(19) United States
(12) Patent Application Publication
(10) Pub. No.: US 2006/0018524 A1
(43) Pub. Date: Jan. 26, 2006

(54) Computerized scheme for distinction between benign and malignant nodules in thoracic low-dose CT

(75) Inventors: Kenji Suzuki, Clarendon Hills, IL (US); Kunio Doi, Willowbrook, IL (US)

Correspondence Address: OBLON, SPIVAK, MCCLELLAND, MAIER & NEUSTADT, P.C., 1940 DUKE STREET, ALEXANDRIA, VA, 22314, US

(73) Assignee: UC Tech, Chicago, IL (US)

(21) Appl. No.: 11/181,884

(22) Filed: Jul. 15, 2005

Related U.S. Application Data
(60) Provisional application No. 60/587,855, filed on Jul. 15, 2004.

(51) Int. Cl. G06K 9/00

(52) U.S. Cl. 382/128

(57) ABSTRACT

A system, method, and computer program product for classifying a target structure in an image into abnormality types. The system has a scanning mechanism that scans a local window across sub-regions of the target structure by moving the local window across the image to obtain sub-region pixel sets. A mechanism inputs the sub-region pixel sets into a classifier to provide output pixel values based on the sub-region pixel sets, each output pixel value representing a likelihood that respective image pixels have a predetermined abnormality, the output pixel values collectively determining a likelihood distribution output image map. A mechanism scores the likelihood distribution map to classify the target structure into abnormality types. The classifier can be, e.g., a single-output or multiple-output massive training artificial neural network (MTANN).

### STATEMENT REGARDING FEDERALLY SPONSORED RESEARCH

The present invention was made in part with U.S. Government support under USPHS Grant No. CA62625. The U.S. Government may have certain rights to this invention.

### BACKGROUND OF THE INVENTION

Field of the Invention

The present invention relates generally to the automated detection of structures and assessment of abnormalities in medical images, and more particularly to methods, systems, and computer program products therefore.

The present invention also generally relates to computerized techniques for automated analysis of digital images, for example, as disclosed in one or more of U.S. Pat. Nos. 4,839,807; 4,841,555; 4,851,984; 4,875,165; 4,907,156; 4,918,534; 5,072,384; 5,133,020; 5,150,292; 5,224,177; 5,289,374; 5,319,549; 5,343,390; 5,359,513; 5,452,367; 5,463,548; 5,491,627; 5,537,485; 5,598,481; 5,622,171; 5,638,458; 5,657,362; 5,666,434; 5,673,332; 5,668,888; 5,732,697; 5,740,268; 5,790,690; 5,832,103; 5,873,824; 5,881,124; 5,931,780; 5,974,165; 5,982,915; 5,984,870; 5,987,345; 6,011,862; 6,058,322; 6,067,373; 6,075,878; 6,078,680; 6,088,473; 6,112,112; 6,138,045; 6,141,437; 6,185,320; 6,205,348; 6,240,201; 6,282,305; 6,282,307; 6,317,617; 6,466,689; 6,363,163; 6,442,287; 6,335,980; 6,594,378; 6,470,092; 6,483,934; 6,678,399; 6,738,499; 6,754,380; 6,819,790; and 6,891,964 as well as U.S. patent application Ser. Nos. 08/398,307; 09/759,333; 09/760,854; 09/773,636; 09/816,217; 09/830,562; 09/818,831; 10/120,420; 10/270,674; 09/990,377; 10/078,694; 10/079,820; 10/126,523; 10/301,836; 10/355,147; 10/360,814; 10/366,482; 10/703,617; and 60/587,855, all of which are incorporated herein by reference.

The present invention is also related to systems for displaying the likelihood of malignancy of a mammographic lesion, as is described, e.g., in U.S. application Ser. No. 10/754,522 (Publication No. 2004/0184644), which is incorporated herein by reference in its entirety.

The present invention includes the use of various technologies referenced and described in the above-noted U.S. Patents and Applications, as well as described in the documents identified in the following LIST OF REFERENCES, which are cited throughout the specification by the corresponding reference number in brackets:

### LIST OF REFERENCES

1. A. Jemal, T. Murray, A. Samuels, A. Ghafoor, E. Ward, and M. J. Thun, “Cancer statistics, 2003,” CA Cancer Journal for Clinicians, vol. 53, no. 1, pp. 5-26, January 2003.
2. O. S. Miettinen and C. I. Henschke, “CT screening for lung cancer: coping with nihilistic recommendations,” Radiology, vol. 221, no. 3, pp. 592-596, December 2001.
3. M. Kaneko, K. Eguchi, H. Ohmatsu, R. Kakinuma, T. Naruke, K. Suemasu, and N. Moriyama, “Peripheral lung cancer: screening and detection with low-dose spiral CT versus radiography,” Radiology, vol. 201, no. 3, pp. 798-802, December 1996.
4. S. Sone, S. Takashima, F. Li, Z. Yang, T. Honda, Y. Maruyama, M. Hasegawa, T. Yamada, K. Kubo, K. Hanamura, and K. Asakura, “Mass screening for lung cancer with mobile spiral computed tomography scanner,” Lancet, vol. 351, pp. 1242-1245, April 1998.
5. C. I. Henschke, D. I. McCauley, D. F. Yankelevitz, D. P. Naidich, G. McGuinness, O. S. Miettinen, D. M. Libby, M. W. Pasmantier, J. Koizumi, N. K. Altorki, and J. P. Smith, “Early lung cancer action project: overall design and findings from baseline screening,” Lancet, vol. 354, pp. 99-105, July 1999.
6. C. I. Henschke, D. P. Naidich, D. F. Yankelevitz, G. McGuinness, D. I. McCauley, et al. “Early lung cancer action project: initial finding on repeat screening,” Cancer, vol. 92, no. 1, pp. 153-159, July 2001.
7. S. J. Swensen, J. R. Jett, T. E. Hartman, D. E. Midthun, J. A. Sloan, A. M. Sykes, G. L. Aughenbaugh, and M. A. Clemens, “Lung cancer screening with CT: Mayo Clinic experience,” Radiology, vol. 226, no. 3, pp. 756-761, March 2003.
8. S. Sone, F. Li, Z. G. Yang, T. Honda, Y. Maruyama, S. Takashima, M. Hasegawa, S. Kawakami, K. Kubo, M. Haniuda, and T. Yamanda, “Results of three-year mass screening programme for lung cancer using mobile low-dose spiral computed tomography scanner,” British Journal of Cancer, vol. 84, no. 1, pp. 25-32, January 2001.
9. T. Nawa, T. Nakagawa, S. Kusano, Y. Kawasaki, Y. Sugawara, and H. Nakata, “Lung cancer screening using low-dose spiral CT,” Chest, vol. 122, no. 1, pp. 15-20, July 2002.
10. F. Li, S. Sone, H. Abe, H. MacMahon, S. G. Armato, and K. Doi, “Lung cancer missed at low-dose helical CT screening in a general population: comparison of clinical, histopathologic, and imaging findings,” Radiology, vol. 225, no. 3, pp. 673-683, December 2002.
11. K. Suzuki, I. Horiba, N Sugie, and M. Nanki, “Noise reduction of medical X-ray image sequences using a neural filter with spatiotemporal inputs,” Proc Int. Symp. Noise Reductionfor Imag. and Comm. Systems, pp. 85-90, November 1998.
12. K. Suzuki, I. Horiba, N. Sugie, and M. Nanki, “Neural filter with selection of input features and its application to image quality improvement of medical image sequences,” IEICE Trans. Information and Systems, vol. E85-D, no. 10, pp. 1710-1718, October 2002.
13. K. Suzuki, I. Horiba, and N. Sugie, “Neural edge detector a good mimic of conventional one yet robuster against noise,” Lecture Notes in Computer Science, vol. 2085, pp. 303-310, June 2001.
14. K. Suzuki, I. Horiba, and N. Sugie, “Neural edge enhancer for supervised edge enhancement from noisy images,” IEEE Trans. Pattern Analysis and Machine Intelligence, vol. 25, no. 12, pp. 1582-1596, December 2003.
15. K. Suzuki, I. Horiba, N. Sugie, and M. Nanki, “Extraction of left ventricular contours from left ventriculograms by means of a neural edge detector,” IEEE Trans. on Medical Imaging, vol. 23, no. 3, March 2004, pp 330-339.
16. K. Suzuki, I. Horiba, and N. Sugie, “Training under achievement quotient criterion,” IEEE Neural Networks for Signal Processing X, pp. 537-546, 2000.
17. K. Suzuki, I. Horiba, and N. Sugie, “Simple unit-pruning with gain-changing training,” IEEE Neural Networks for Signal Processing XI, pp. 153-162, 2001.
18. K. Suzuki, I. Horiba, and N. Sugie, “Designing the optimal structure of a neural filter,” IEEE Neural Networks for Signal Processing VIII, pp. 323-332, 1998.
19. K. Suzuki, I. Horiba, and N. Sugie, “A simple neural network pruning algorithm with application to filter synthesis,” Neural Processing Letters, vol. 13, no. 1, pp. 43-53, February 2001.
20. K. Suzuki, I. Horiba, and N. Sugie, “Efficient approximation of neural filters for removing quantum noise from images,” IEEE Trans. Signal Processing, vol. 50, no. 7, pp. 1787-1799, July 2002.
21. K. Suzuki, S. G. Armato, F. Li, S. Sone, and K. Doi, “Massive training artificial neural network (MTANN) for reduction of false positives in computerized detection of lung nodules in low-dose CT,” Medical Physics, vol. 30, no. 7, pp. 1602-1617, July 2003., corresponding to U.S. patent application Ser. No. 10/120,420.
22. K. Suzuki, S. G. Armato, F. Li, S. Sone, and K. Doi, “Effect of a small number of training cases on the performance of massive training artificial neural network (MTANN) for reduction of false positives in computerized detection of lung nodules in low-dose CT,” Proc. SPIE Medical Imaging (SPIE MI), San Diego, Calif., vol. 5032, pp. 1355-1366, May 2003.
23. K. Suzuki, I. Horiba, K. Ikegaya, and M. Nanki, “Recognition of coronary arterial stenosis using neural network on DSA system,” Systems and Computers in Japan, vol. 26, no. 8, pp. 66-74, August 1995.
24. D. E. Rumelhart, G. E. Hinton, and R. J. Williams, “Learning representations of back-propagation errors,” Nature, vol. 323, pp. 533-536, 1986.
25. D. E. Rumelhart, G. E. Hinton, and R. J. Williams, “Learning internal representations by error propagation,” in Parallel Distributed Processing (MIT Press, Cambridge), vol. 1, pp. 318-362, 1986.
26. D. P. Chakraborty and L. H. Winter, “Free-response methodology: alternate analysis and a new observer-performance experiment,” Radiology, vol. 174, no. 3, pp. 873-881, March 1990.
27. K. Funahashi, “On the approximate realization of continuous mappings by neural networks,” Neural Networks, vol. 2, pp. 183-192, 1989.
28. A. R. Barron, “Universal approximation bounds for superpositions of a sigmoidal function,” IEEE Trans. Information Theory, vol. 39, no. 3, pp. 930-945, May 1993.
29. C. E. Metz, “ROC methodology in radiologic imaging,” Invest. Radiol., vol. 21, pp. 720-733, 1986.
30. C. E. Metz, B. A. Herman, and J. H. Shen, “Maximum likelihood estimation of receiver operating characteristic (ROC) curves from continuously-distributed data,” Stat. Med., vol. 17, no. 9, pp. 1033-1053, May 1998.
31. J. A. Hanley and B. J. McNeil, “A method of comparing the areas under receiver operating characteristic curves derived from the same cases,” Radiology, vol. 148, no. 3, pp. 839-843, September 1983.
32. J. Kittler, M. Hatef, R. Duin, and J. Matas, “On combining classifiers,” IEEE Trans. Pattern Analysis and Machine Intelligence, vol. 20, no. 3, pp. 226-239, March 1998.
33. J. Kittler and F. M. Alkoot, “Sum versus vote fusion in multiple classifier systems,” IEEE Trans. Pattern Analysis and Machine Intelligence, vol. 25, no. 1, pp. 110-115, January 2003.
34. Y. Jiang, R. M. Nishikawa, R. A. Schmidt, C. E. Metz, M. L. Giger, and K. Doi, “Improving breast cancer diagnosis with computer-aided diagnosis,” Acad. Radiol., vol. 6, no. 1, pp. 22-33, January 1999.
35. Q. Li, M. Aoyama, F. Li, S. Sone, H. MacMahon, and K. Doi, “Potential clinical usefulness of an intelligent computer-aided diagnostic scheme for distinction between benign and malignant pulmonary nodules in low-dose CT scans,” Radiology, vol. 225(P), no. 2, pp. 534-535, November 2002.
36. Q. Li, F. Li, S. Katsuragawa, J. Shiraishi, H. MacMahon, S. Sone, and K. Doi, “Investigation of new psychophysical measures for evaluation of similar images on thoracic computed tomography for distinction between benign and malignant nodules,” Medical Physics, vol. 30, no. 10, pp. 2584-2593, October 2003.
37. K. Nakamura, H. Yoshida, R. Engelmann, H. MacMahon, S. Katsuragawa, T. Ishida, K. Ashizawa, and K. Doi, “Computerized analysis of the likelihood of malignancy in solitary pulmonary nodules by use of artificial neural networks,” Radiology, vol. 214, no. 3, pp. 823-830, March 2000.
38. M. Aoyama, Q. Li, S. Kasuragawa, H. MacMahon, and K. Doi, “Automated computerized scheme for distinction between benign and malignant solitary pulmonary nodules on chest images,” Medical Physics, vol. 29, no. 5, pp. 701-708, May 2002.
39. Y. Jiang, R. M. Nishikawa, D. E. Wolverton, C. E. Metz, M. L. Giger, R. A. Schmidt, C. J. Vybomy, and K. Doi, “Malignant and benign clustered microcalcifications: Automated feature analysis and classification,” Radiology, vol. 198, no. 3, pp. 671-678, March 1996.
40. Z. Huo, M. L. Giger, C. J. Vyborny, D. E. Wolverton, R. A. Schmidt, and K. Doi, “Automated computerized classification of malignant and benign mass lesions on digitized mammograms,” Acad. Radiol., vol. 5, pp. 155-168, 1998.
41. L. Hadjiiski, B. Sahiner, H.-P. Chan, N. Petrick, and M. Helvie, “Classification of malignant and benign masses based on hybrid ART2LDA approach,” IEEE Transactions on Medical Imaging, vol. 8, no. 12, pp. 1178-1187, 1999.
42. Y. Matsuki, K. Nakamura, H. Watanabe, T. Aoki, H. Nakata, S. Katsuragawa, and K. Doi, “Usefulness of an artificial neural network for differentiating benign from malignant pulmonary nodules on high-resolution CT: evaluation with receiver operating characteristic analysis,” AJR, vol. 178, pp. 657-663, March 2002.
43. M. F. McNitt-Gray, E. M. Hart, N. Wyckoff, J. W. Sayre, J. G. Goldin, and D. R. Aberle, “A pattern classification approach to characterizing solitary pulmonary nodules imaged on high resolution CT: Preliminary results,” Medical Physics, vol. 26, no. 6, pp. 880-888, June 1999.
44. M. Aoyama, Q. Li, S. Katsuragawa, F. Li, S. Sone, and K. Doi, “Computerized scheme for determination of the likelihood measure of malignancy for pulmonary nodules on low-dose CT images,” Medical Physics, vol. 30, no. 3, pp. 387-394, March 2003.
45. P. A. Lachenbruch, Discriminant Analysis, Hafner: New York, pp. 1-39, 1975.
46. E. Oja, Subspace Methods of Pattern Recognition (Research Studies Press, Letchworth, England), 1983.

The contents of each of the above references, including patents and patent applications, are incorporated herein by reference. The techniques disclosed in the patents, patent applications, and other references can be utilized as part of the present invention.

### DISCUSSION OF THE BACKGROUND

Lung cancer continues to rank as the leading cause of cancer deaths among Americans; the number of lung cancer deaths in each year is greater than the combined number of breast, colon, and prostate cancer deaths [1]. Because CT is more sensitive than chest radiography in the detection of small nodules and of lung carcinoma at an early stage [2-4], lung cancer screening programs are being investigated in the United States [2,5-7] and Japan [3,8-10] with low-dose helical CT (LDCT) as the screening modality. It may be difficult, however, for radiologists to distinguish between benign and malignant nodules on LDCT. In a screening program with LDCT in New York, 88% (206/233) of suspicious lesions were found to be benign nodules on follow-up examinations [5]. In a screening program in Japan, only 83 (10%) among 819 scans with suspicious lesions were diagnosed to be cancer cases [10]. According to recent findings at the Mayo Clinic, 2,792 (98.6%) of 2,832 nodules detected by a multidetector CT were benign, and 40 (1.4%) nodules were malignant [7]. Thus, a large number of benign nodules were found with CT; follow-up examinations such as high-resolution CT (HRCT) and/or biopsy were performed on these patients. Therefore, computer-aided diagnostic (CAD) schemes for distinction between benign and malignant nodules in LDCT would be useful for reducing the number of “unnecessary” follow-up examinations.

Suzuki et al. have been investigating supervised nonlinear image-processing techniques based on artificial neural networks (ANNs), called a “neural filter” [11], for reduction of the quantum mottle in x-ray images [12] and a “neural edge detector” [13,14] for supervised detection of subjective edges traced by cardiologists [15], and they have developed training methods [16,17], design methods [18,19], and an analysis method [20] for these techniques. Suzuki et al. recently extended the neural filter and the neural edge detector to accommodate various pattern-classification tasks, and they developed an MTANN. They have applied the MTANN for reduction of false positives in computerized detection of lung nodules in LDCT [21,22]. However, the method of Suzuki et al. is not capable of providing a continuous score, between (i) a first value corresponding to a malign nodule and (ii) a second value corresponding to a benign nodule.

### SUMMARY OF THE INVENTION

Accordingly, in one embodiment of the present invention a CAD scheme was developed for distinguishing between benign and malignant nodules in LDCT by use of a new pattern-classification technique based on a massive training artificial neural network (MTANN).

According to one aspect of the present invention there is provided a novel method, system and computer program product for classifying a target structure in an image into abnormality types, including scanning a local window across sub-regions of the structure by moving the local window across the image, so as to obtain respective sub-region pixel sets; inputting the sub-region pixel sets into a classifier, wherein the classifier provides, corresponding to the sub-regions, respective output pixel values that each represent a likelihood that respective image pixels have a predetermined abnormality, the output pixel values collectively determining a likelihood distribution output image map; and scoring the likelihood distribution map to classify the structure into abnormality types.

According to another aspect of the present invention there is provided a novel method, system, and computer program product for determining a likelihood of a predetermined abnormality for a target structure in an image, comprising: (1) scanning a local window across sub-regions of the image to obtain respective sub-region pixel sets; (2) inputting the sub-region pixel sets to N classifiers, N being an integer greater than 1, the N classifiers being configured to output N respective outputs, wherein each of the N classifiers provides, corresponding to the sub-regions, respective output pixel values that each represent a likelihood that respective image pixels have the predetermined abnormality, the output pixel values collectively determining a likelihood distribution map; (3) scoring the N likelihood distribution maps determined by the N classifiers in the inputting step to generate N respective scores indicating whether the target structure is the predetermined abnormality; and (4) combining the N scores determined in the scoring step to determine an output value indicating a likelihood that the target structure is the predetermined abnormality.

According to another aspect of the present invention there is provided a novel method, system, and computer program product for determining likelihoods of predetermined abnormality types for a target structure in an image, comprising: (1) scanning a local window across sub-regions of the image to obtain respective sub-region pixel sets; (2) inputting the sub-region pixel sets to N classifiers, N being an integer greater than 1, each of the N classifiers being configured to output N outputs, wherein each output of each of the N classifiers provides, corresponding to the sub-regions, respective output pixel values that each represent a likelihood that respective image pixels have one of the predetermined abnormality types, the output pixel values for each output of each of the N classifiers collectively determining a likelihood distribution map so that N² likelihood distribution maps are determined for the image; (3) scoring, for each of the N classifiers, the N likelihood distribution maps determined by each classifier in the inputting step to generate N respective scores for each classifier indicating, for each classifier, whether the target structure is one of the predetermined abnormality types so that N² scores are determined for the image; and (4) combining, for each abnormality type of the predetermined abnormality types, N scores, one score associated with each of the N classifiers and indicating whether the target structure is of the abnormality type, to obtain an output value indicating a likelihood that the target structure is of the abnormality type, so that N output values are determined, one for each abnormality type of the predetermined abnormality types.

According to another aspect of the present invention there is provided a system for indicating the likelihood that a lesion in a medical image is one of a first or second type of abnormality, comprising: (1) a first classifier, configured to analyze a subset of the image, the first classifier being optimized to recognize the first type of abnormality, and configured to output a first score indicative of the likelihood that the lesion is of the first or second type of abnormality; (2) a second classifier, configured to analyze a subset of the image, the second classifier being optimized to recognize the second type of abnormality, and configured to output a second score indicative of the likelihood that the lesion is of the first or second type; and (3) a third classifier, configured to combine the first and second scores and to output a third score indicative of the likelihood that the lesion is of the first or second type.

According to another aspect of the present invention there is provided a system for indicating at least one score indicative of the likelihood that a target lesion in a medical image is one of a first, second, or third type of abnormality, comprising: (1) a first classifier, configured to analyze a subset of the image, the first classifier being optimized to recognize the first type of abnormality, and configured to output a first set of three scores, which indicate, respectively, the likelihood that the target lesion is of the first, second, or third type of abnormality; (2) a second classifier, configured to analyze a subset of the image, the second classifier being optimized to recognize the second type of abnormality, and configured to output a second set of three scores, which indicate, respectively, the likelihood that the target lesion is of the first, second, or third type of abnormality; (3) a third classifier, configured to analyze a subset of the image, the third classifier being optimized to recognize the third type of abnormality, and configured to output a third set of three scores, which indicate, respectively, the likelihood that the target lesion is of the first, second, or third type of abnormality; (4) a fourth classifier, configured to combine the three scores from the first, second, and third classifiers that indicate that the target lesion is of the first type of abnormality, and to output a tenth score indicative of the likelihood that the target lesion is of the first type of abnormality; (5) a fifth classifier, configured to combine the three scores from the first, second, and third classifiers that indicate that the target lesion is of the second type of abnormality and to output a eleventh score indicative of the likelihood that the target lesion is of the second type of abnormality; (6) a sixth classifier, configured to combine the three scores from the first, second, and third classifiers that indicate that the target lesion is of the third type of abnormality and to output a twelfth score indicative of the likelihood that the target lesion is of the third type of abnormality; and (7) a graphical user interface configured to display a representation of at least one of the tenth, eleventh, and twelfth scores.

According to another aspect of the present invention there is provided a system for indicating at least one score indicative of the likelihood that a target lesion in a medical image is one of N types of abnormality, comprising: (1) a first set of N classifiers, wherein each classifier in the first set is configured to analyze a subset of the image, and each classifier is optimized to recognize a different one of the N types of abnormalities, and each classifier in the first set is configured to output a first set of N scores, wherein each of the N scores outputted by each classifier indicates the likelihood that the target lesion is one of a different one of the N types of abnormalities; (2) a second set of N classifiers, wherein each classifier in the second set is configured to combine the one score outputted by each of the first set of N classifiers that indicates that the target lesion is of a single type of abnormality, and wherein each classifier in the second set is configured to combine a different set of N scores; and wherein each of the second set of N classifiers is configured to output one element of a set of N combined scores each indicating the likelihood that the target lesion is of the said single type of abnormality; and (3) a graphical user interface configured to display a representation of at least one of the set of N combined scores.

According to another aspect of the present invention there is provided a system for indicating the likelihood that an identified region in a medical image is a malignant lesion, or one of a plurality of benign types of abnormalities, comprising: (1) a first classifier configured to analyze a subset of the image, the first classifier optimized to output a first score indicating whether the identified region is a malignant lesion; (2) a plurality of additional classifiers each configured to analyze a subset of the image and each optimized to output additional scores indicating whether the suspicious region is one of the different benign types of abnormalities; (3) a combining classifier configured to combine the first score and the additional scores and to output a set of final scores indicating the likelihoods that the identified region contains a malignant lesion, or one of the plurality of benign types of abnormalities.

According to another aspect of the present invention there is provided a system for indicating the likelihood that an identified region in a medical image is one of a plurality of types of abnormalities, comprising: (1) a plurality of classifiers each configured to analyze a subset of the image and each optimized to output a first score indicating whether the identified region is one of the different types of abnormalities; (2) a combining classifier configured to combine the set of first scores and to output a set of final scores indicating the likelihoods that the identified region contains one of the plurality of types of abnormalities; and (3) a graphical user interface configured to display at least one indicator representative of at least one final score of the set of final scores.

According to another aspect of the present invention there is provided a system for indicating the likelihood that an identified region in an image of a lung is one of N types of abnormalities, comprising: (1) N classifiers each configured to analyze a subset of the image and each optimized to output one of a first set of N scores indicating whether the identified region is one of the different types of abnormalities; (2) an additional combining classifier, configured to combine the first set of scores and to output at least one final score indicating at least one likelihood that the identified region is one of the plurality of types of abnormalities; and (3) a graphical user interface configured to display at least one indicator representative of the at least one final score.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, in which like reference numerals refer to identical or corresponding parts throughout the several views, and in which:

FIG. 1 illustrates an architecture and training of an exemplary massive training artificial neural network (MTANN) to distinguish between benign and malignant nodules;

FIGS. 2(a) and 2(b) illustrate an architecture and a flow chart of a multiple MTANN (Multi-MTANN) incorporating an integration artificial neural network (ANN) for distinguishing malignant nodules from various benign nodules;

FIG. 3 shows illustrations of training samples of four malignant nodules (top row) and six sets of four benign nodules for six MTANNs in the Multi-MTANN;

FIG. 4 shows illustrations of the output images of the six trained MTANNs for malignant nodules (left four images) and benign nodules (right four images), which correspond to the training samples in FIG. 3 (note that the output images of each MTANN for malignant nodules correspond to the same four input images in FIG. 3);

FIGS. 5(a) and 5(b) show illustrations of (a) four non-training malignant nodules (top row) and six non-training sets of four benign nodules, and (b) the corresponding output images of the six trained MTANNs in the Multi-MTANN for malignant nodules (left four images) and benign nodules (right four images);

FIG. 6 shows illustration of three types of nodule patterns, i.e., pure GGO, mixed GGO, and solid nodule, and the corresponding output images of the trained MTANN no. 1 for non-training cases;

FIG. 7 shows an ROC curve of each MTANN in the Multi-MTANN in distinction between 66 non-training malignant nodules and 403 non-training benign nodules;

FIG. 8 shows distributions of the output values of the integration ANN for 76 malignant nodules and 413 benign nodules in the round-robin test;

FIG. 9 shows ROC curves of schemes according to one embodiment of the present invention in distinction between malignant and benign nodules;

FIG. 10 shows the effect of the change in the number of MTANNs in one embodiment of the Multi-MTANN on the performance of the scheme in the round-robin test;

FIG. 11 shows the effect of the change in the number of hidden units in one embodiment of the integration ANN on the performance of the scheme in the round-robin test;

FIGS. 12(a) and 12(b) illustrate an architecture and a flow chart of a multi-output MTANN for an N-class classification according to one embodiment of the present invention;

FIGS. 13(a) and 13(b) illustrate an architecture and a flow chart of a multiple multi-output MTANN with integration ANNs for classification of diseases having various patterns;

FIG. 14 shows the effect of the change of a set of training nodules (malignant and benign nodules) on the performance of the MTANN;

FIG. 15 shows the learning curve of MTANN no. 1 and the effect of the number of training times on the generalization performance of the MTANN;

FIG. 16 shows the effect of the change in the standard deviation σ of the 2D Gaussian weighting function for scoring on the performance of MTANN no. 1;

FIGS. 17(a) and (b) show the distribution of samples extracted from the database in the principal component (PC) vector space in which black crosses represent samples (sub-regions) extracted from the training cases, gray dots represent samples extracted from all cases in the database, while FIG. 17(a) shows the relationship between the first and second PCs. FIG. 17(b) shows the relationship between the third and fourth PCs; and

FIG. 18 shows a block diagram of a computer system and its main components.

### DETAILED DESCRIPTION OF THE PREFERRED EMBODIMENTS

In describing preferred embodiments of the present invention illustrated in the drawings, specific terminology is employed for the sake of clarity. However, the invention is not intended to be limited to the specific terminology so selected, and it is to be understood that each specific element includes all technical equivalents that operate in a similar manner to accomplish a similar purpose. Moreover, features and procedures whose implementations are well known to those skilled in the art, such as initiation and testing of loop variables in computer programming loops, are omitted for brevity.

The present invention provides various image-processing and pattern recognition techniques in arrangements that may be called a massive training artificial neural networks (MTANNs) and their extension, Multi-MTANNs.

For the purposes of this description an image is defined to be a representation of a physical scene, in which the image has been generated by some imaging technology. Examples of imaging technology could include television or CCD cameras or X-ray, sonar or ultrasound imaging devices. The initial medium on which an image is recorded could be an electronic solid-state device, a photographic film, or some other device such as a photostimulable phosphor. That recorded image could then be converted into digital form by a combination of electronic (as in the case of a CCD signal) or mechanical/optical means (as in the case of digitising a photographic film or digitising the data from a photostimulable phosphor). The number of dimensions which an image could have could be one (e.g. acoustic signals), two (e.g. X-ray radiological images) or more (e.g. CT or nuclear magnetic resonance images).

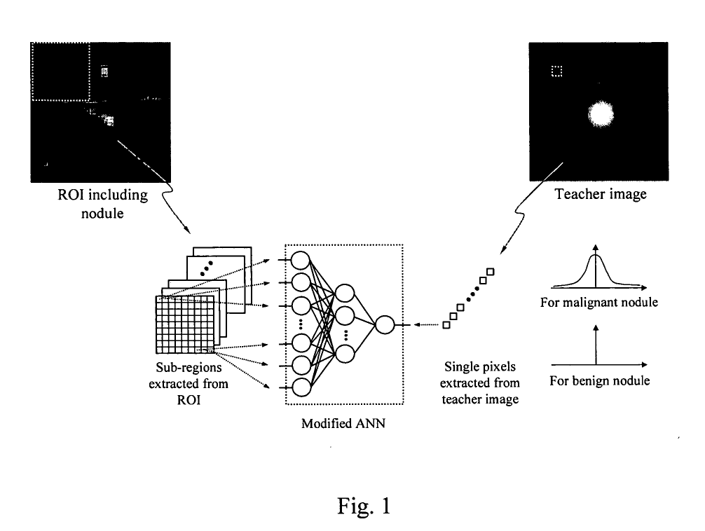

The architecture and the training method of a typical MTANN used for two-dimensional images are shown in FIG. 1. The pixel values in the sub-regions extracted from the region of interest (ROI) are entered as input to the MTANN. The single pixel corresponding to the input sub-region, which is extracted from the teacher image, is used as a teacher value. The MTANN is a highly nonlinear filter that can be trained by use of input images and the corresponding teacher images. The MTANN typically consists of a modified multilayer ANN [23], which is capable of operating on image data directly. The MTANN typically employs a linear function instead of a sigmoid function as the activation function of the unit in the output layer because the characteristics of an ANN were often significantly improved with a linear function when applied to the continuous mapping of values in image processing, (See reference [14] for example).

The pixel values of the original CT images are typically normalized first such that −1000 HU (Hounsfield units) is zero and 1000 HU is one. The inputs of the MTANN are the pixel values in a local window R_{S} on a region of interest (ROI) in a CT image. The output of the MTANN is a continuous value, which corresponds to the center pixel in the local window, represented by
O(x,y)=NN{I(x−i,y−j)|i, jεR_{S}}, (1)
where
O(x,y) is the output of the MTANN,
x and y are the indices of coordinates,
NN{•} is the output of the modified multilayer ANN, and
I(x,y) is an input pixel value.

Note that only one unit is typically employed in the output layer. The output image is obtained by scanning of an input image with the MTANN.

For distinguishing malignant nodules from benign nodules, the teacher image is designed to contain the distribution for the “likelihood of being a malignant nodule,” i.e., the teacher image for a malignant nodule should contain a certain distribution, the peak of which is located at the center of the malignant nodule. For a benign nodule, the teacher image should contain zeros. For two-dimensional LDCT slices, a two-dimensional (2D) Gaussian function is used, with a standard deviation σ_{T} at the center of the malignant nodule as the distribution for the likelihood of being a malignant nodule. The training region R_{T} in the input image is divided pixel by pixel into a large number of overlapping sub-regions, the size of which corresponds to that of the local window R_{S} of the MTANN.

The MTANN is trained by presenting each of the input sub-regions together with each of the corresponding teacher single pixels. The error to be minimized by training is defined by

$$E = \frac{1}{P} {\sum }_{p} {\{ {T}^{( p )} - {O}^{( p )} \}}^{2} , \qquad ( 2 )$$

where
p is a training pixel number,
T^{(p)} is the pth training pixel in R_{T} in the teacher images,
O^{(p)} is the pth training pixel in R_{T} in the output images, and
P is the number of training pixels.

The MTANN is trained by a modified back-propagation (BP) algorithm [23], which was derived for the modified multilayer ANN, i.e., a linear function is employed as the activation function of the unit in the output layer, in the same way as the original BP algorithm [24,25]. After training, the MTANN is expected to output the highest value when a malignant nodule is located at the center of the local window of the MTANN, a lower value as the distance from the center increases, and zero when the input region contains a benign nodule.

The database used to develop the CAD consisted of 76 primary lung cancers in 73 patients and 413 benign nodules in 342 patients, which were obtained from a lung cancer screening program on 7,847 screenees with LDCT for three years in Nagano, Japan [4]. All cancers were confirmed histopathologically at either surgery or biopsy. During the initial clinical reading, all benign nodules were reported as lesions suspected to be lung cancer or indeterminate lung lesions, but were not reported as benign cases. The CT examinations were performed on a mobile CT scanner (CT-W950SR; Hitachi Medical, Tokyo, Japan). The scans used for this study were acquired with a low-dose protocol of 120 kVp, 25 mA or 50 mA, 10-mm collimation, and a 10-mm reconstruction interval at a helical pitch of two. The pixel size was 0.586 mm or 0.684 mm. Each reconstructed CT section had an image matrix size of 512×512 pixels. The nodule size ranged from 3 mm to 29 mm. When a nodule was present in more than one section, the section with the greatest size was used in this study. Approximately 30% of the lung cancers were attached to the pleura, 34% of cancers were attached to vessels, and 7% of cancers were in the hilum. Three chest radiologists determined the cancers in three categories such as pure ground-glass opacity (pure GGO; 24% of cancers), mixed GGO (30%), and solid nodule (46%). Thus, this database included various types of nodules of various sizes.

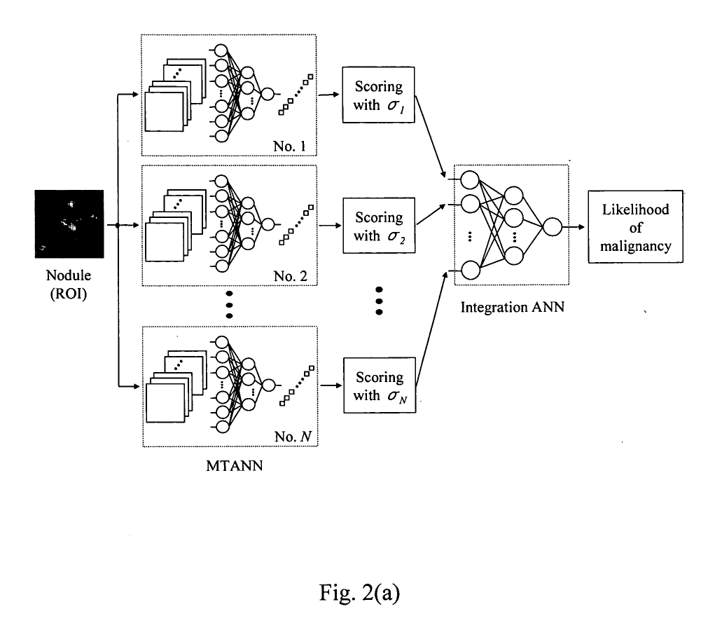

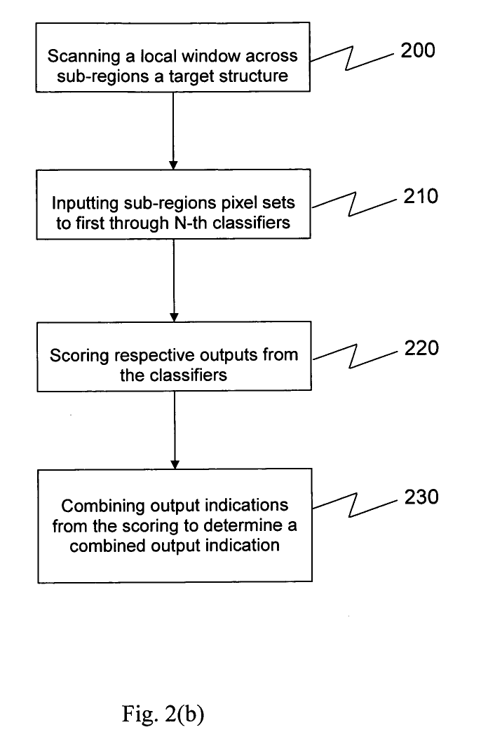

In order to distinguish malignant nodules from various types of benign nodules, one embodiment of the present invention extended the capability of a single MTANN and developed a multiple MTANN (Multi-MTANN) [21]. The architecture of the Multi-MTANN is shown in FIG. 2(a). The Multi-MTANN includes plural MTANNs that are arranged in parallel. Each MTANN is trained by use of benign nodules representing a different benign type, but with the same malignant nodules. Each MTANN acts as an expert for distinguishing malignant nodules from a specific type of benign nodule.

The distinction between a malignant nodule and a benign nodule is determined by use of a score defined based on the output image of the trained MTANN, as described below:

$${S}_{s} = {\sum }_{x , y ∈ {R}_{E}} {f}_{G} ( {σ}_{s} ; x , y ) \times {O}_{s} ( x , y ) , \qquad ( 3 )$$

where
Sₛ is the score for the sth nodule,
R_{E} is the region for evaluation,
Oₛ(x,y) is the output image of the MTANN for the sth nodule where its center corresponds to the center of R_{E}, and
f_{G}(σₛ;x,y) is a 2D Gaussian function with a standard deviation σₛ, where its center corresponds to the center of R_{E}.

This score represents the weighted sum of the estimate for the likelihood that the image contains a malignant nodule near the center, i.e., a higher score would indicate a malignant nodule, and a lower score would indicate a benign nodule.

The scores from the expert MTANNs in the Multi-MTANN are combined by use of an integration ANN such that different types of benign nodules can be distinguished from malignant nodules. An average operation is an alternative way of combining the expert MTANN scores. Other classifiers can be used for combining the expert MTANN scores, including linear discriminant analysis, quadratic discriminant analysis, and support vector machines. The integration ANN consists of a modified multilayer ANN with a modified BP training algorithm [23] for processing continuous output/teacher values. The scores of each MTANN are entered to each input unit in the integration ANN; thus, the number of input units corresponds to the number of MTANNs.

The score of each MTANN functions like a feature characterizing a specific type of the benign nodule. One unit is employed in the output layer for distinguishing between a malignant nodule and a benign nodule. The teacher values for the malignant nodules are assigned the value one, and those for benign nodules are zero. After training, the integration ANN is expected to output a higher value for a malignant nodule, and a lower value for a benign nodule. Thus, the output can be considered to be a value related to a “likelihood of malignancy” of a nodule. If the scores of each MTANN characterize the specific type of benign nodule with which the MTANN is trained, then the integration ANN combining several MTANNs will be able to distinguish malignant nodules from various types of benign nodules.

Referring to FIG. 2(b) flow chart in conjunction with FIG. 2(a), during classifying a target structure, a local window is scanned in step 200 across sub-regions of the target structure by moving the local window across the image to obtain respective sub-region pixel sets. In step 210, the sub-region pixel sets are inputted into multiple MTANNs (first through N-th classifiers). The multiple MTANNs output first through N-th respective outputs. In step 220, each first through N-th respective outputs are scored to provide output indications of whether a structure in the image is a type of first through N-th mutually different abnormality types. In step 230, an integration ANN (a combining classifier) combines the output indications to determine a combined output indication (likelihood of malignancy) of whether the target structure is one of the first through N-th mutually different abnormality types.

In one of exemplary embodiment, the benign nodules into eight groups by using a method for determining training cases for a Multi-MTANN [22]. With this method, training cases for each MTANN were determined based on the ranking in the scores in the free-response receiver operating characteristic (FROC) [26] space. Ten typical malignant nodules and ten benign nodules were selected from each of the groups. Six groups from the eight groups were determined to be used as training cases for the Multi-MTANN by an empirical analysis (described later).

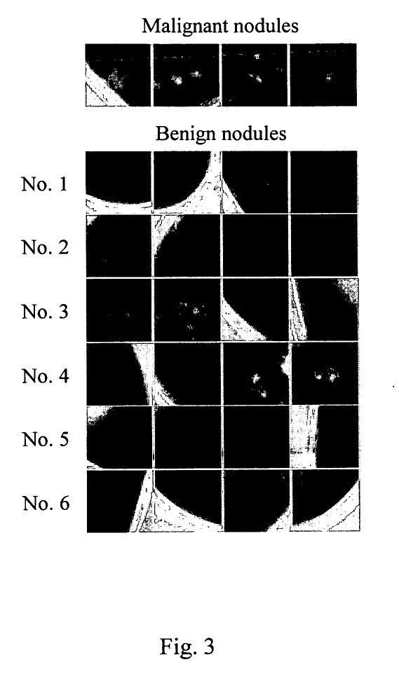

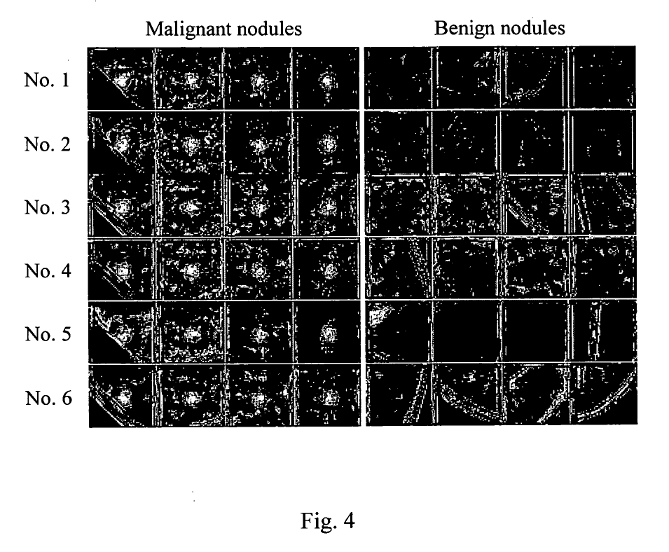

FIG. 3 shows samples of the training cases for malignant and benign nodules. The six groups included (1) small nodules overlapping with vessels, (2) medium-sized nodules with fuzzy edges, (3) medium-sized nodules with sharp edges and relatively small nodules with light background, (4) medium-sized nodules with high contrast and medium-sized nodules with light background, (5) small nodules with fuzzy edges, and (6) small nodules near the pleura.

A three-layer structure was employed as the structure of the MTANN, because any continuous mapping can be realized approximately by the three-layer ANNs [27,28].

The size of the local window R_{S} of the MTANN, the standard deviation σ_{T} of the 2D Gaussian function, and the size of the training region RT in the teacher image were determined empirically to be 9×9 pixels, 5.0 pixels, and 19×19 pixels, respectively. The number of hidden units was determined to be 20 units by empirical analysis. Thus, the numbers of units in the input, hidden, and output layers were 81, 20, and 1, respectively.

With the above parameters, the training of each MTANN in the Multi-MTANN was performed 500,000 times. The training of each MTANN required a CPU time of 29.8 hours on a PC-based workstation (CPU: Pentium IV, 1.7 GHz). The output images of each trained MTANN for training cases are shown in FIG. 4.

The scores of each trained MTANN in the Multi-MTANN were used as inputs to the integration ANN with a three-layer structure. The number of hidden units in the integration ANN was determined empirically to be four (as described later). Thus, the numbers of units in the input, hidden, and output layers were six, four, and one, respectively. The training of the integration ANN was performed 1,000 times with the round-robin (leave-one-out) test. With this test, one nodule was excluded from all nodules, and the remaining nodules were used for training of the integration ANN. After training, the one nodule excluded from training cases was used for testing. This process was repeated for each of the nodules one by one, until all nodules were tested.

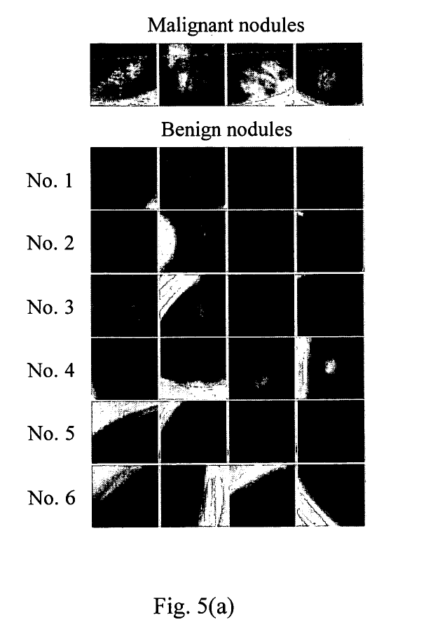

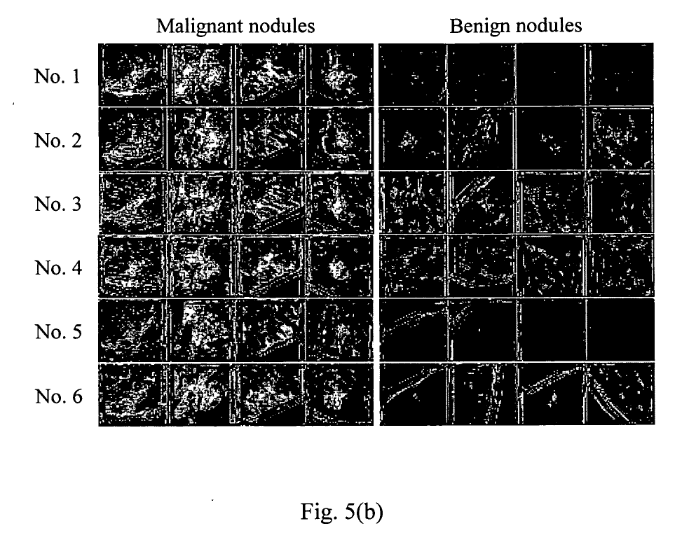

The trained MTANNs in the Multi-MTANN were applied to the database of 76 malignant nodules and 413 benign nodules. FIGS. 5(a) and 5(b) show input images and the corresponding output images of each of the six MTANNs for non-training cases. The malignant nodules in the output images of the MTANN were represented by light distributions near the centers of the nodules, whereas the benign nodules in the corresponding group for which the MTANN was trained in the output images were mostly dark around the center, as expected.

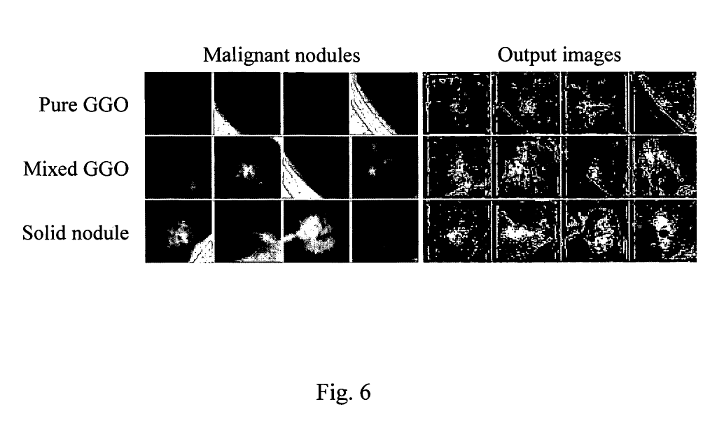

FIG. 6 shows non-training malignant nodules representing three major types of patterns, i.e., pure GGO, mixed GGO, and solid nodule, and the corresponding output images of the MTANN no. 1 for distinguishing malignant from benign nodules in the group (1).

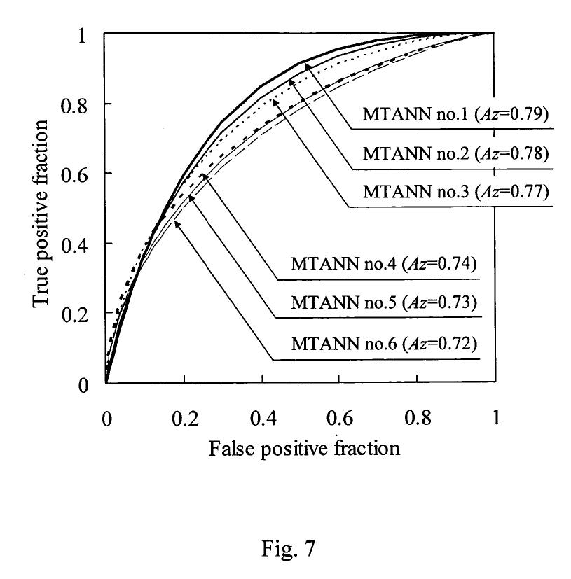

All three types of nodules are represented by light distributions. The scoring method was applied to the output images. The performance of each MTANN was evaluated by receiver operating characteristic (ROC) analysis [29,30]. FIG. 7 shows the ROC curve of each MTANN for non-training cases of 66 malignant nodules and 403 benign nodules. The scores from each MTANN characterized benign nodules appropriately, i.e., the scores from the MTANN for benign nodules in the corresponding group were low, whereas those for malignant nodules were substantially high.

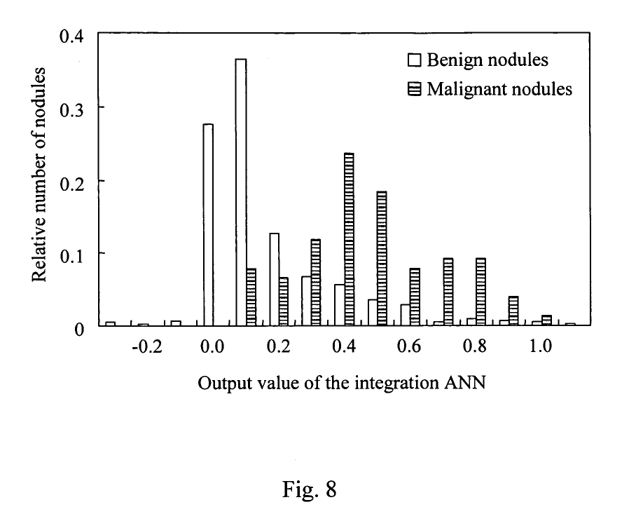

FIG. 8 shows the distributions of the output values of the trained integration ANN for the 76 malignant nodules and 413 benign nodules in the round-robin test. The performance of the scheme according to the present embodiment, based on the Multi-MTANN incorporated with the integration ANN, was evaluated by ROC analysis.

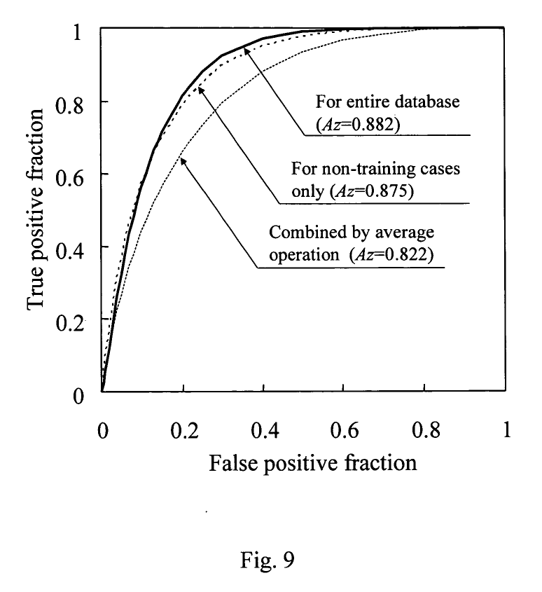

FIG. 9 shows the ROC curve of the used scheme. The solid curve indicates the performance (A_{z} value of 0.882) of the scheme in distinction between 76 malignant nodules and 413 benign nodules in the round-robin test. The performance is higher at high sensitivity levels. The dashed curve indicates the performance (A_{z} value of 0.875) of our scheme for non-training cases of 66 malignant nodules and 353 benign nodules. The dotted curve indicates the performance (A_{z} value of 0.822) of the Multi-MTANN, the outputs of which were combined with the average operation. This scheme achieved an A_{z} value (area under the ROC curve) [31] of 0.882 in the round-robin test. The performance for non-training cases, i.e., the training cases of ten malignant nodules and 60 benign nodules were excluded from the cases for evaluation, was almost the same (A_{z} value of 0.875). The ROC curve was higher at high sensitivity levels. This allows the scheme of the present embodiment to distinguish many benign nodules without loss of a malignant nodule. The scheme correctly identified 100% (76/76) of malignant nodules as malignant, and 48% (200/413) of benign nodules were correctly identified as benign.

The inventors of the present invention investigated the effect of the change in the number of MTANNs in the Multi-MTANN on the performance of the scheme of the present embodiment. The performance was evaluated by ROC analysis. The number of MTANNs corresponds to the number of input units in the integration ANN. The integration ANN was evaluated by use of a round-robin test.

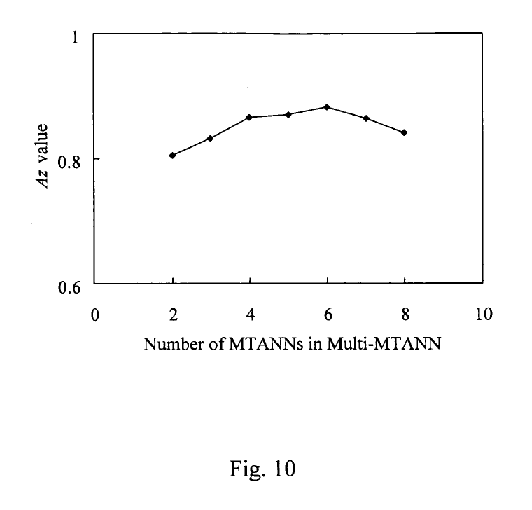

FIG. 10 shows the A_{z} values of the schemes used with various numbers of MTANNs. The results show that the performance of the scheme was the highest when the number of MTANNs was six.

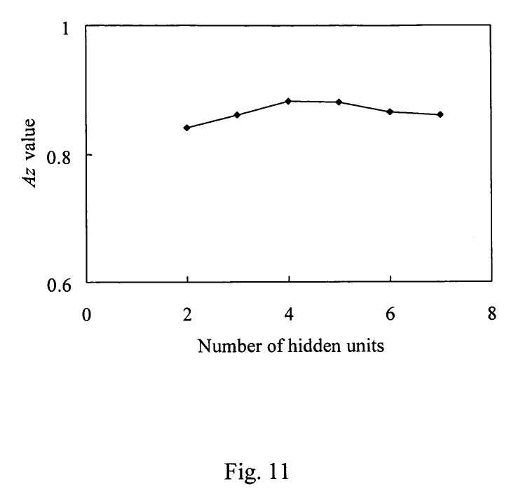

The effect of the change in the number of the hidden units was investigated in the integration ANN in the scheme. The integration ANN was evaluated by use of the round-robin test. The number of MTANNs (i.e., the number of input units) was six. FIG. 11 shows the performance of the scheme with various numbers of hidden units. The performance was not sensitive to the number of hidden units.

The performance of the integration ANN was compared with that of another method for combining the outputs of the Multi-MTANN. An average operation is often used for combining multiple classifiers, and has been compared to majority logic [32,33]. The average operation was performed on the scores from the six MTANNs in the Multi-MTANN. The performance of the Multi-MTANN combined with the average operation is shown in FIG. 9. In this Example, the performance of the average operation (A_{z} value of 0.822) was apparently inferior to that of the integration ANN.

The logical AND operation was used to combine the scores from each MTANN in the Multi-MTANN for application to false-positive reduction in CAD for lung nodule detection on LDCT [21], because the scheme should output a binary value, i.e., a true positive (nodule) or a false positive (non-nodule) for the purpose of reduction of false positives when the AND operation is used. For radiologists' classification task such as distinguishing between benign and malignant nodules in LDCT, however, the likelihood of malignancy is displayed with a proper marker on a nodule rather than only a simple marker indicating a malignant nodule as an aid in radiologists' decision-making.

The proper marker for indicating the likelihood of malignancy includes a display method in which (1) a likelihood of malignancy from 0% to 100% is placed around the nodule, (2) a likelihood of malignancy with a certain symbol, e.g., a number, a star, or a Greek letter, is placed outside a CT image (or ROI) and an arrow with the symbol is placed around the nodule, (3) a mark whose gray tone (or color) is related to a likelihood of malignancy is placed around the nodule (e.g., back indicates 0%, and white indicates 100%), and (4) a mark whose size is related to a likelihood of malignancy is placed around the nodule (e.g., a small circle indicates 0%, and a big circle indicates 100%). The use of the integration ANN allows the scheme to provide the likelihood of malignancy which is a continuous value, whereas the logical AND operation cannot output a continuous value. The likelihood of malignancy can be calculated from the output values of the integration ANN in the scheme of the present embodiment by use of the relationship defined in Ref. [34]. In addition, the output of the integration ANN can be employed as a binary decision by use of a threshold value. Thus, the scheme of the present embodiment can be used for providing either the likelihood of malignancy of a nodule or a malignant nodule marker by combining the present scheme with a detection scheme [21].

A detection scheme might include one or a combination of the following schemes: (1) a selective enhancement filters-based detection scheme, (2) a difference-image techniques-based detection scheme, (3) a morphological filters-based detection scheme, (4) a multiple gray-level thresholding-based detection scheme, (5) a model-based detection scheme, (6) a detection scheme incorporating an ANN, (7) a detection scheme incorporating a support vector machine, (8) a detection scheme incorporating linear discriminant analysis, and (9) a detection scheme incorporating quadratic discriminant analysis.

In order to evaluate the radiologists' performance in distinguishing between benign and malignant nodules on LDCT, the inventors performed an observer study [35,36]. The inventors randomly selected 20 malignant nodules and 20 benign nodules from the database. Sixteen radiologists (ten attending radiologists and six radiology residents) participated in this study. The ROC analysis was used for evaluation of the performance of the radiologists. The radiologists were asked whether the nodule was benign or malignant, and then they marked their confidence level regarding the likelihood of malignancy by using a continuous rating scale. An average Az value of 0.70 was obtained by the 16 radiologists in the observer study, whereas the scheme of the present embodiment achieved a higher Az value (0.882) than did the radiologists. Therefore, the scheme of the present embodiment would be useful in improving radiologists' classification accuracy.

Computerized schemes have been developed for distinction between benign and malignant lesions in chest radiographs [37,38], mammograms [39-41], and CT images [42-44]. Aoyama et al. have developed a computerized scheme for distinguishing between benign and malignant lung nodules in LDCT. Table 1 shows the difference between Aoyama's scheme and a scheme of the present embodiment based on the MTANN.

TABLE 1
Difference between Aoyama's scheme and the scheme of the present
embodiment based on the MTANN

| | Aoyama's segmentation-based | MTANN- |
|---|---|---|
| | scheme | based scheme |
| Segmentation | Radial search of edge candidates | No segmentation |
| | based on edge magnitude and | |
| | contour smoothness | |
| Feature | Three gray-level-based features, | Multi-MTANN (pixel- |
| analysis | two edge-based features, and | based determination of |
| | one morphological feature, | likelihood of |
| | plus clinical information | malignancy from |
| | | sub-regions) |
| Classification | Linear discriminant analysis | Integration ANN |
| Performance | 0.828 | 0.882 |

The other classifiers (or classification schemes) other than the MTANN may work better for a certain type of nodule. By combining such a classifier (or a classification scheme) with the MTANN, a better performance can be obtained. First, nodules are grouped into a particular type of nodule (e.g., the size of nodules is less than 3 mm) and other types of nodules. The nodules with the particular type are entered into the classifier, and the rest of nodules are entered into the MTANN. If the performance of the classifier is better than that of the MTANN for the particular type of nodules, the overall performance of the combined scheme is better than the performance of the MTANN or the classifier alone. The classifier or the classification scheme can include (1) Aoyama's scheme, (2) an ANN, (3) a radial-basis function network, (4) a support vector machine, (5) linear discriminant analysis, and (6) quadratic discriminant analysis.

The performance (Az value of 0.882) of the present scheme was greater than that of Aoyama's scheme of 0.828[44] for the same cases in the same database. Aoyama's scheme was based on segmentation of nodules, feature analysis of the nodules, and linear discriminant analysis [45] for distinguishing between benign and malignant nodules. The segmentation was performed by use of the radial search of edge candidates based on edge magnitude and contour smoothness. The features of a nodule included three gray-level-based features, two edge-based features, a morphological feature, and clinical information. However, an accurate segmentation is difficult in the Aoyama's scheme. Therefore, incorrect segmentation can occur for complicated patterns such as nodules overlapping with vessels and subtle opacities like GGO. On the contrary, the use of MTANN does not require segmentation, but only image data directly. Therefore, there is no room for errors due to incorrect segmentation when the MTANN is employed. This is a major advantage of the MTANN of the present embodiment for classification of lung nodules in CT.

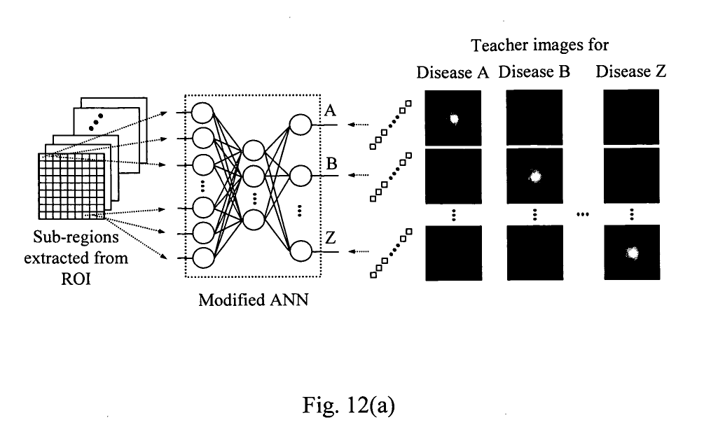

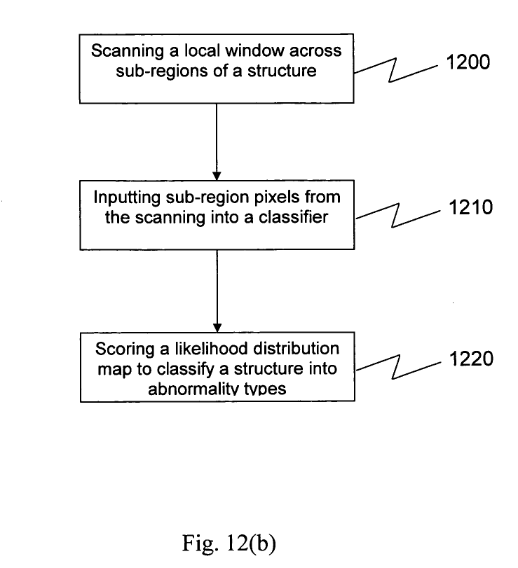

For a classification of opacities into multiple diseases, the MTANN can be extended to accommodate the task of an N-class classification problem, and can be developed as a multi-output MTANN. FIGS. 12(a) and 12(b) show the architecture and a flow chart of the multi-output MTANN for the N-class classification.

The multi-output MTANN has plural output units for multiple-class (disease) classification. The number of outputs in the multi-output MTANN is the number of classes to be classified (i.e., N). Each output unit corresponds to each class. When the input ROI is a certain class, the teacher image for the corresponding output unit contains a 2D Gaussian distribution, while the teacher images for other output units contain zero, as shown in FIG. 12(a). For example, when the ROI contains the opacity for the disease A, the teacher image for the output unit A (i.e., for the disease A) contains a 2D Gaussian distribution, while the teacher images for other output units B to Z (i.e., for diseases B to Z) contain zeros.

After training with these teacher images, the multi-output MTANN expects to learn the relationships among those diseases. When the ROI contains a certain disease, the corresponding output unit in the trained multi-output MTANN will output higher values, and other output units will output lower values. The scoring method is applied to each output unit independently. The opacity in the input ROI is determined to be the disease which corresponds to the output unit with the maximum score among the scores from all output units.

FIG. 12(b) shows the flow chart for classifying a target structure in an image into abnormalities types based on the multi-output MTANN discussed with reference to FIG. 12(a). In step 1200, a local window is scanned across sub-regions of the structure by moving the local window across the image to obtain respective sub-region pixel sets. In step 1210, the sub-region pixel sets are inputted into the multiple-output MTANN (a classifier), which provides, corresponding to the sub-regions, respective output pixel values that each represent a likelihood that respective image pixels have a predetermined abnormality, the output pixel values collectively determining a likelihood distribution output image map. In step 1220, the plural output units of the multiple-output MTANN provides, corresponding to the sub-regions, respective output pixel values that each representing a likelihood that respective image pixels have one of predetermined abnormalities, the output pixel values collectively determining plural likelihood distribution maps, and also scoring the likelihood distribution maps to classify the target structure into abnormality types.

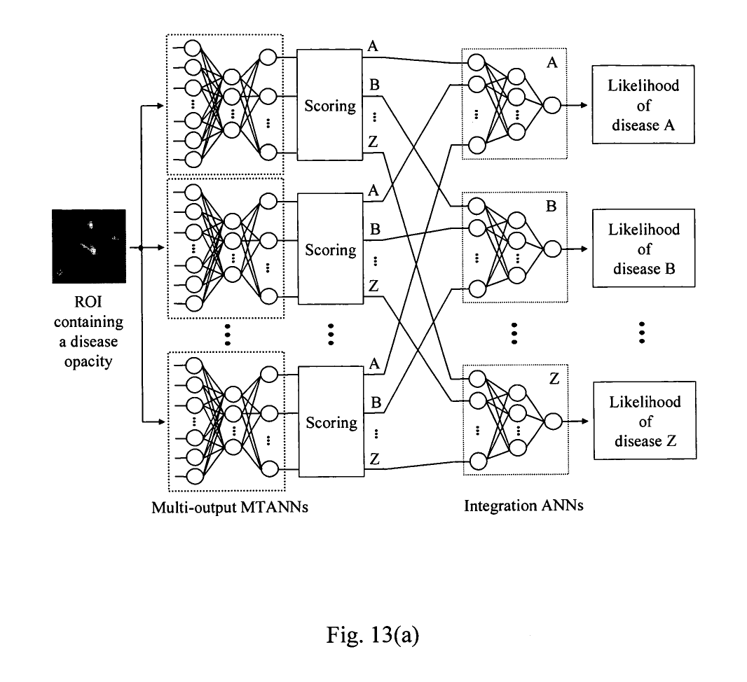

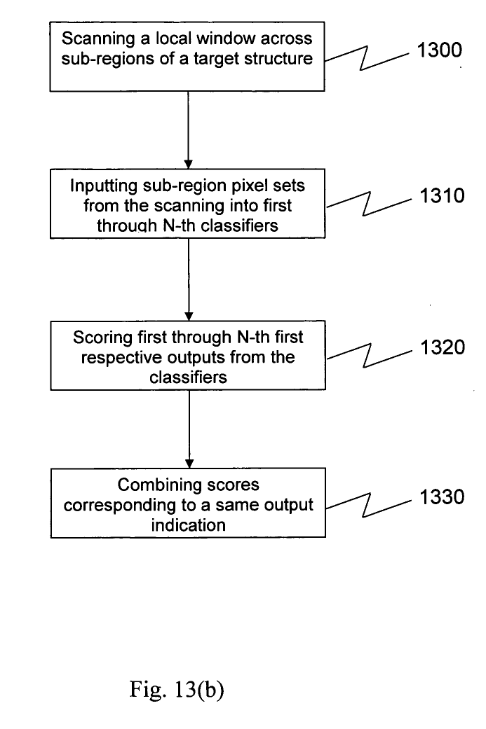

There are large variations in patterns for a simple disease. It is difficult for a single multi-output MTANN to classify the diseases having such large variations, because the capability of the MTANN is limited. In order to classify the opacities with large pattern variations, a multiple multi-output MTANN with integration ANNs was developed, which consists of plural multi-output MTANNs arranged in parallel and plural integration ANNs for multiple-class (disease) classification, as shown in FIG. 13(a). Each multi-output MTANN is trained independently with different patterns of diseases so that each MTANN is an expert for the disease with a specific pattern. After training, the scoring method is applied to each output unit of the multi-output MTANN independently. Scores from the multi-output MTANNs are entered to plural integration ANNs, each of which is in charge of a specific disease; thus, the number of the integration ANNs corresponds to the number of classes (diseases). The scores from the output units of the multi-output MTANNs, which correspond to a certain disease, are entered to the corresponding integration ANN.

FIG. 13(b) shows a flow chart for classifying a malign nodule (target structure) into predefined types (diseases that are discussed below). In step 1300, a local window is scanned across sub-regions of the target structure by moving the local window across the image to obtain respective sub-region pixel sets. In step 1310, the sub-region pixel sets are input into first through N-th MTANNs (classifiers), N being an integer greater than 1, each of the first through N-th classifiers being configured to provide first through N-th first respective outputs. In step 1320, the first through N-th first respective outputs are scored to provide first respective output indications (A to Z in FIG. 13(a)) of whether a structure in the image is a type of first through N-th mutually different predefined types. In step 1330, the scores corresponding to a same first respective output indications are combined in a plurality of integration ANNs to provide first through N-th second respective output indications of whether the target structure in the image is the type of first through N-th mutually different predefined types.

When the input ROI contains a certain disease, the teacher value for the corresponding integration ANN is 1.0, and the teacher values for other integration ANNs are zeros. After training of the integration ANNs with these teacher values, each integration ANN will output the likelihood of the corresponding disease. This scheme is applicable to classification of multiple-diseases such as diffuse lung diseases in chest radiographs and CT. Other examples or diseases are (1) fibrosis, (2) scleroderma, (3) polymyositis, (4) rheumatoid arthritis, (5) dermatopolymyositis, (6) aspiration pneumonia, (7) pleural effusion, (8) pulmonary fibrosis, (9) pulmonary hypertension, (10) scleroderma pulmonary, (11) autoimmune interstitial pneumonia, (12) pulmonary veno-occlusive disease, (12) shrinking lung syndrome, (13) lung cancer, and (14) pulmonary embolism. However, the above list is exemplary and not exhaustive.

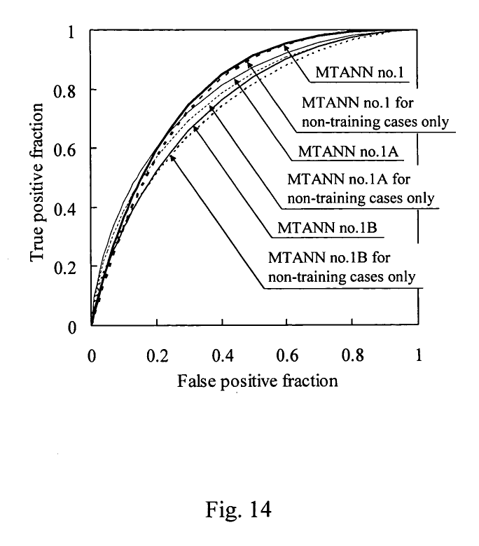

The effect of the change in the number of training nodules on the performance of the MTANN has been investigated based on seven sets with different numbers of typical malignant and benign nodules selected from the entire database according to their visual appearance, so that a set of a smaller number of training nodules is a subset of a larger number of training nodules. Seven MTANNs were trained with the seven sets with different numbers of nodules from four (two malignant nodules and two benign nodules) to 60 (30 malignant nodules and 30 benign nodules). The performance of the MTANNs was evaluated by use of ROC analysis. FIG. 14 shows the results for non-training nodules, i.e., the 60 training nodules were excluded from the cases for evaluation. There was little increase in the Az value when the number of training nodules was greater than 20 (ten malignant nodules and ten benign nodules). This is the reason for the use of 20 training nodules for the MTANN. This result was consistent with that in Ref. [21].

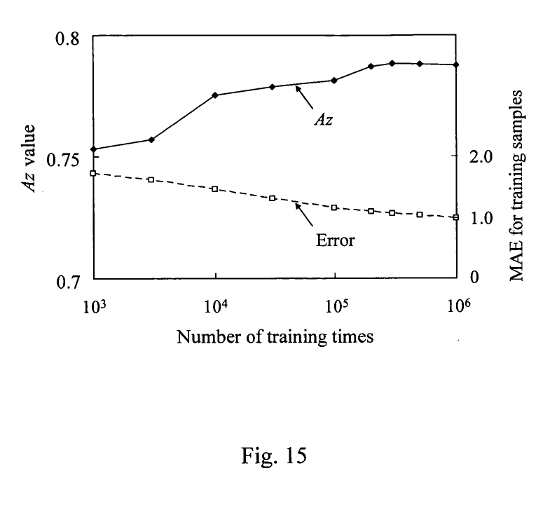

The property of the MTANN regarding an overtraining issue was also investigated. FIG. 15 shows a learning curve (mean absolute error (MAE) for training samples) of MTANN no. 1 and the effect of the number of training times on the generalization performance (Az values for non-training cases). There was little increase in the Az value when the number of training times was greater than 200,000, and there was a slight decrease at 1,000,000 times. This is the reason for determining the condition for stopping of the training at 500,000. Note that a significant overtraining was not seen. This result was consistent with that in Ref. [21].

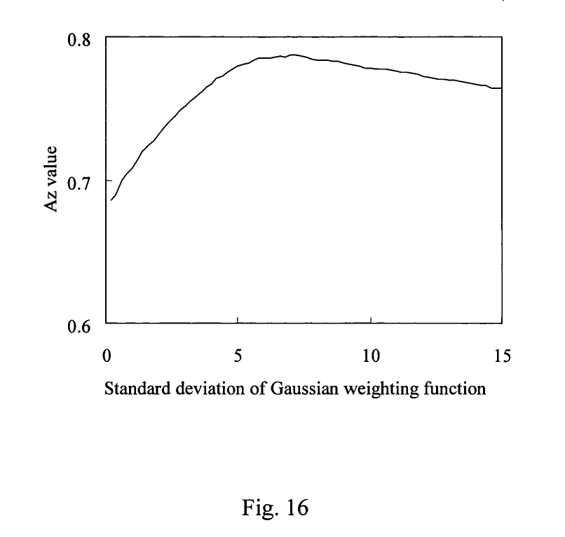

Also, the effect of a parameter change on the performance of the MTANN was investigated. The standard deviation σ of the 2D Gaussian weighting function for scoring the MTANN no. 1 was changed, and the performance for the non-training cases was obtained, as shown in FIG. 16. Because the performance was the highest at a standard deviation of 7.5, this value was used for the MTANN no. 1. Thus, the performance was not sensitive to the standard deviation σ. This result was consistent with that in the distinction between nodules and non-nodules in CT images in Ref. [21]. Similarly, the standard deviations for other MTANNs was determined to be 7.5 or 8.0.

In order to gain insight into the training of the MTANN, the information used by the MTANN was analyzed. The input of the MTANN can be considered as an 81-dimensional (81-D) input vector. In the MTANN approach, each case (nodule image) is divided into a large number (361) of sub-regions. Each sub-region corresponds to the 81-D input vector. If a large number of 81-D input vectors obtained from the training cases (e.g., ten malignant nodules) approximate those obtained from all cases in the database (i.e., 76 malignant nodules), the MTANN trained with these training cases can potentially have a high generalization ability. Because it is difficult to visualize and compare all 81 dimensions of the input vector, the principal-component analysis (PCA, also referred to as Karhune-Loeve analysis) [46] was employed for reducing the dimensions.

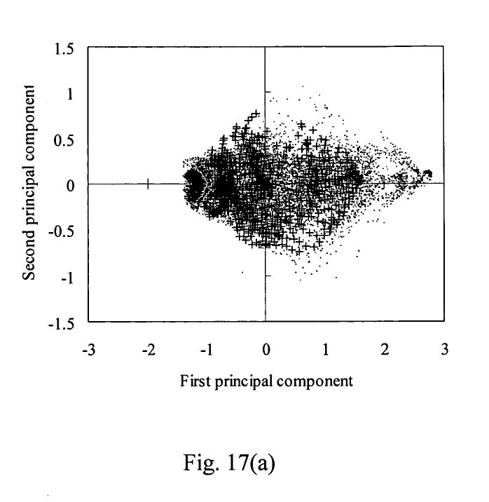

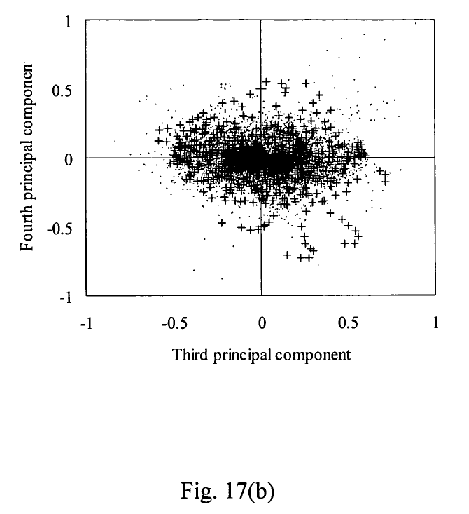

The PCA was applied to 81-D vectors obtained from all 76 malignant nodules. FIGS. 17(a) and (b) show the distributions of samples (sub-regions) extracted from the ten training malignant nodules and all 76 malignant nodules in the database in the principal component (PC) vector space. Only the first to fourth PCs are shown in the figures, because the cumulative contribution rate of the fourth PC is 0.974, i.e., the figures represent 97.4% of all data. The result showed that the ten training cases represent the 76 cases fairly well except for the right portion of the distribution in the relationship between the first and second PCs in figure (a). The right portion of the distribution is very sparse, containing only 6% of all samples. This does not mean that the training nodules do not cover 6% of the 76 nodules, but that the training nodules do not cover, on average, 6% of the components of each nodule. Because all components of each nodule are combined with the scoring method in the MTANN, the non-covered 6% of components would not be critical at all for the classification accuracy. Thus, the division of each nodule case into a large number of sub-regions enriched the variations in the feature components of nodules, and therefore contributed to the generalization ability of the MTANN.

The MTANN according to one embodiment of the present invention can handle three-dimensional volume data by increasing the numbers of input units and hidden units. Thus, the MTANN is applicable to new modalities such as MRI, ultrasound, multi-slice CT and cone-beam CT for computerized classification of lung nodules. However, the present scheme can be applied to other classifications as discussed later.

The three-dimensional (3D) MTANN is trained with input CT volumes and the corresponding teaching volumes for enhancement of a specific opacity and suppression of other opacities in 3D multi-detector-row CT (MDCT) volumes. Voxel values of the original CT volumes are normalized first such that −1000 HU is zero and 1000 HU is one. The input of the 3D MTANN is the voxel values in a sub-volume V_{S} extracted from an input CT volume. The output O(x,yz) of the 3D MTANN is a continuous value, which corresponds to the center voxel in the sub-volume, represented by
O(x, y, x)=NN(\vec{I}_{x y,z}) (3)
where
   \vec{I}_{x,y,z}={I(x−i,y−j,z−k)|i,j,kεV_{S}}, (4)
   is the input vector to the 3D MTANN,
x, y, and z are the indices of the coordinates,
NN{•} is the output of a linear-output multilayer ANN, and
I(x,y,z) is the normalized voxel value of the input CT volume.

Note that only one unit is employed in the output layer. The linear-output multilayer ANN employs a linear function instead of a sigmoid function as the activation function of the output unit because the characteristics of an ANN were improved significantly with a linear function when applied to the continuous mapping of values in image processing. The output volume is obtained by scanning of an input CT volume with the 3D MTANN.

For distinguishing between nodules and non-nodules, a scoring method based on the output volume of the trained 3D MTANNs is performed. A score for a given nodule candidate from the n^{th} 3D MTANN is defined by

$$\begin{matrix}{S}_{n} = {\sum }_{x , y , z ∈ {V}_{E}} {f}_{G} ( {σ}_{n} ; x , y , z ) \times {O}_{n} ( x , y , z ) , \\ where & ( 5 ) \\ {f}_{G} ( {σ}_{n} ; x , y , z ) = \frac{1}{\sqrt{2 π} {σ}_{n}} exp \{ - \frac{( {x}^{2} + {y}^{2} + {z}^{2} )}{2 {σ}_{n}^{2}} \} & ( 6 )\end{matrix}$$

is a 3D Gaussian weighting function with a standard deviation σₙ, with its center corresponding to the center of the volume for evaluation V_{E}; and
Oₙ(x,y,z) is the output volume of the n^{th} trained 3D MTANN, where its center corresponds to the center of V_{E}.

The use of the 3D Gaussian weighting function allows the responses (outputs) of a trained 3D MTANN to be combined as a 3D distribution. This score represents the weighted sum of the estimates for the likelihood that the volume (nodule candidate) contains a nodule near the center, i.e., a higher score would indicate a nodule, and a lower score would indicate a non-nodule.

In order to distinguish between nodules and various types of non-nodules, the single 3D MTANN was extended and developed as a multiple 3D MTANN (multi-3D MTANN). The multi-3D MTANN consists of plural 3D MTANNs that are arranged in parallel. Each 3D MTANN is trained by using a different type of non-nodule, but with the same nodules. Each 3D MTANN acts as an expert for distinction between nodules and a specific type of non-nodule, e.g., 3D MTANN No. 1 is trained to distinguish nodules from false positives caused by medium-sized vessels; 3D MTANN No. 2 is trained to distinguish nodules from soft-tissue-opacity false positives caused by the diaphragm; and so on. A scoring method is applied to the output of each 3D MTANN, and then a threshold is applied to the score from each 3D MTANN for distinguishing between nodules and the specific type of non-nodule. The output of each 3D MTANN is then integrated by the logical AND operation. If each 3D MTANN can eliminate the specific type of non-nodule with which the 3D MTANN is trained, then the multi-3D MTANN will be able to reduce a larger number of false positives than does a single 3D MTANN.

In the multi-3D MTANN, the distribution in the output volume of each trained 3D MTANN may be different according to the type of non-nodule trained. The output from each trained 3D MTANN is scored independently by use of a 3D Gaussian function with a different standard deviation σₙ. The distinction between nodules and the specific type of non-nodule is determined by applying a threshold to the score with a different threshold θₙ for each trained 3D MTANN, because the appropriate threshold for each trained 3D MTANN may be different according to the type of non-nodule trained. The threshold θₙ may be determined by use of a training set so as not to remove any nodules, but eliminate non-nodules as much as possible. The outputs of the expert 3D MTANNs are combined by use of the logical AND operation such that each of the trained 3D MTANNs eliminates none of the nodules, but removes some of the specific type of non-nodule for which the 3D MTANN was trained.

The scheme of the embodiments of the present invention may be applied to virtually any field in which a target pattern must be classified. Systems trained as described above can classify target objects (or areas) that humans might intuitively recognize at a glance. For example, the invention may be applied to the following fields, in addition to the medical imaging application that was described above: detection of faulty wiring in semiconductor integrated circuit pattern images; classification of mechanical parts in robotic eye images; classification of guns, knives, box cutters, or other weapons or prohibited items in X-ray images of baggage; classification of airplane shadows, submarine shadows, schools of fish, and other objects, in radar or sonar images; classification of missiles, missile launchers, tanks, personnel carriers, or other potential military targets, in military images; classification of weather pattern structures such as rain clouds, thunderstorms, incipient tornadoes or hurricanes, and the like, in satellite and radar images; classification of areas of vegetation from satellite or high-altitude aircraft images; classification of patterns in woven fabrics, for example, using texture analysis; classification of seismic or geologic patterns, for use in oil or mineral prospecting; classification of stars, nebulae, galaxies, and other cosmic structures in telescope images; etc.

The present computerized scheme for distinguishing between benign and malignant nodules based on the Multi-MTANN incorporated with the integration ANN achieved a relatively high Az value of 0.882, and would be useful in assisting radiologists in the diagnosis of lung nodules in LDCT by reducing the number of “unnecessary” HRCTs and/or biopsies.

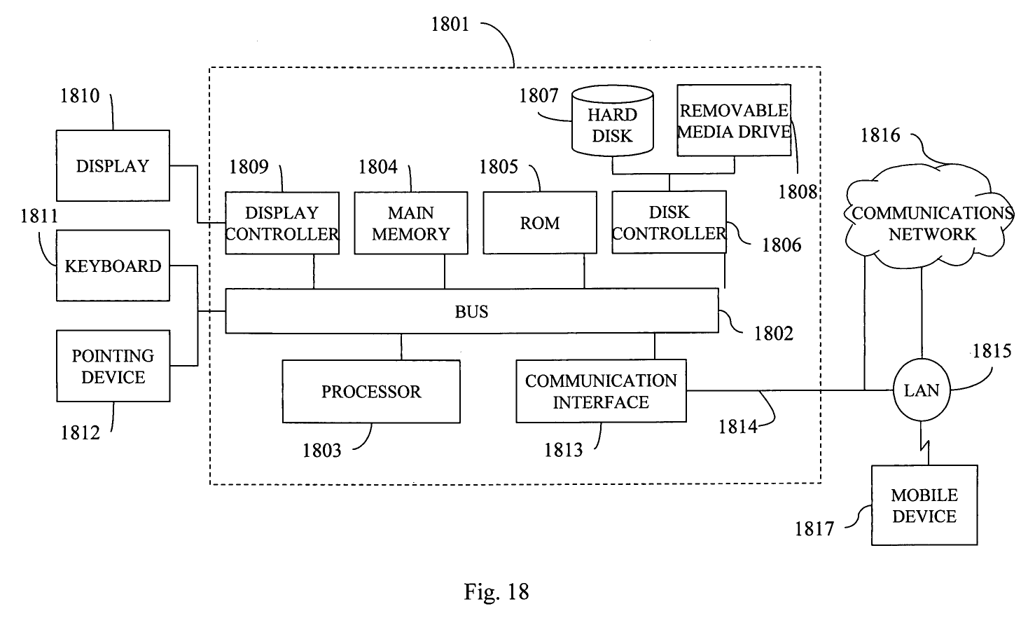

Finally, FIG. 18 illustrates a computer system 1801 upon which an embodiment of the present invention may be implemented. All, or just selected, processing components of the embodiments discussed herein may by implemented. The computer system 1801 includes a bus 1802 or other communication mechanism for communicating information, and a processor 1803 coupled with the bus 1802 for processing the information. The computer system 1801 also includes a main memory 1804, such as a random access memory (RAM) or other dynamic storage device (e.g., dynamic RAM (DRAM), static RAM (SRAM), and synchronous DRAM (SDRAM)), coupled to the bus 1802 for storing information and instructions to be executed by processor 1803. In addition, the main memory 1804 may be used for storing temporary variables or other intermediate information during the execution of instructions by the processor 1803. The computer system 1801 further includes a read only memory (ROM) 1805 or other static storage device (e.g., programmable ROM (PROM), erasable PROM (EPROM), and electrically erasable PROM (EEPROM)) coupled to the bus 1802 for storing static information and instructions for the processor 1803.

The computer system 1801 also includes a disk controller 1806 coupled to the bus 1802 to control one or more storage devices for storing information and instructions, such as a magnetic hard disk 1807, and a removable media drive 1808 (e.g., floppy disk drive, read-only compact disc drive, read/write compact disc drive, compact disc jukebox, tape drive, and removable magneto-optical drive). The storage devices may be added to the computer system 1801 using an appropriate device interface (e.g., small computer system interface (SCSI), integrated device electronics (IDE), enhanced-IDE (E-IDE), direct memory access (DMA), or ultra-DMA).

The computer system 1801 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 1801 may also include a display controller 1809 coupled to the bus 1802 to control a display 1810, such as a cathode ray tube (CRT), for displaying information to a computer user. The computer system includes input devices, such as a keyboard 1811 and a pointing device 1831, for interacting with a computer user and providing information to the processor 1803. The pointing device 1831, for example, may be a mouse, a trackball, or a pointing stick for communicating direction information and command selections to the processor 1803 and for controlling cursor movement on the display 1810. In addition, a printer may provide printed listings of data stored and/or generated by the computer system 1801.

The computer system 1801 performs a portion or all of the processing steps of the invention in response to the processor 1803 executing one or more sequences of one or more instructions contained in a memory, such as the main memory 1804. Such instructions may be read into the main memory 1804 from another computer readable medium, such as a hard disk 1807 or a removable media drive 1808. One or more processors in a multi-processing arrangement may also be employed to execute the sequences of instructions contained in main memory 1804. In alternative embodiments, hard-wired circuitry may be used in place of or in combination with software instructions. Thus, embodiments are not limited to any specific combination of hardware circuitry and software.

As stated above, the computer system 1801 includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system 1801, for driving a device or devices for implementing the invention, and for enabling the computer system 1801 to interact with a human user (e.g., print production personnel). Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any medium that participates in providing instructions to the processor 1803 for execution. A computer readable medium may take many forms, including but not limited to, non-volatile media, volatile media, and transmission media. Non-volatile media includes, for example, optical, magnetic disks, and magneto-optical disks, such as the hard disk 1807 or the removable media drive 1808. Volatile media includes dynamic memory, such as the main memory 1804. Transmission media includes coaxial cables, copper wire and fiber optics, including the wires that make up the bus 1802. Transmission media also may also take the form of acoustic or light waves, such as those generated during radio wave and infrared data communications.

Various forms of computer readable media may be involved in carrying out one or more sequences of one or more instructions to processor 1803 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to the computer system 1801 may receive the data on the telephone line and use an infrared transmitter to convert the data to an infrared signal. An infrared detector coupled to the bus 1802 can receive the data carried in the infrared signal and place the data on the bus 1802. The bus 1802 carries the data to the main memory 1804, from which the processor 1803 retrieves and executes the instructions. The instructions received by the main memory 1804 may optionally be stored on storage device 1807 or 1808 either before or after execution by processor 1803.

The computer system 1801 also includes a communication interface 1813 coupled to the bus 1802. The communication interface 1813 provides a two-way data communication coupling to a network link 1814 that is connected to, for example, a local area network (LAN) 1815, or to another communications network 1816 such as the Internet. For example, the communication interface 1813 may be a network interface card to attach to any packet switched LAN. As another example, the communication interface 1813 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 1813 sends and receives electrical, electromagnetic or optical signals that carry digital data streams representing various types of information.

The network link 1814 typically provides data communication through one or more networks to other data devices. For example, the network link 1814 may provide a connection to another computer through a local network 1815 (e.g., a LAN) or through equipment operated by a service provider, which provides communication services through a communications network 1816. The local network 1814 and the communications network 1816 use, for example, electrical, electromagnetic, or optical signals that carry digital data streams, and the associated physical layer (e.g., CAT 5 cable, coaxial cable, optical fiber, etc). The signals through the various networks and the signals on the network link 1814 and through the communication interface 1813, which carry the digital data to and from the computer system 1801 maybe implemented in baseband signals, or carrier wave based signals. The baseband signals convey the digital data as unmodulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as unmodulated baseband data through a “wired” communication channel and/or sent within a predetermined frequency band, different than baseband, by modulating a carrier wave. The computer system 1801 can transmit and receive data, including program code, through the network(s) 1815 and 1816, the network link 1814 and the communication interface 1813. Moreover, the network link 1814 may provide a connection through a LAN 1815 to a mobile device 1817 such as a personal digital assistant (PDA) laptop computer, or cellular telephone.

Readily discernible modifications and variations of the present invention are possible in light of the above teachings. It is therefore to be understood that within the scope of the appended claims, the invention may be practiced otherwise than as specifically described herein. For example, while described in terms of both software and hardware components interactively cooperating, it is contemplated that the system described herein may be practiced entirely in software. The software may be embodied in a carrier such as magnetic or optical disk, or a radio frequency or audio frequency carrier wave.

1. A method of classifying a target structure in an image into predetermined abnormality types, comprising:
scanning a local window across sub-regions of the image to obtain respective sub-region pixel sets;
inputting the sub-region pixel sets into a classifier, wherein the classifier provides, corresponding to the sub-regions, respective output pixel values that each represent a likelihood that respective image pixels have a predetermined abnormality, the output pixel values collectively determining a likelihood distribution map; and
scoring the likelihood distribution map to classify the target structure into the predetermined abnormality types.

2. The method of claim 1, wherein the classifier includes plural output units so that the classifier provides, corresponding to the sub-regions, respective output pixel values for each of the plural output units that each represent a likelihood that respective image pixels have one of the predetermined abnormality types, the output pixel values for each output unit collectively determining a likelihood distribution map, so that plural likelihood distribution maps are determined, and
wherein the scoring step comprises scoring each likelihood distribution map to classify the target structure.

3. The method of claim 2, further comprising:
comparing the scores from the plural output units of the classifier to classify the target structure into one of the predetermined abnormality types.

4. The method of claim 3, wherein the comparing step comprises:
calculating a maximum score among the scores determined in the scoring step.

5. A system for classifying a target structure in an image into predetermined abnormality types, comprising:
a scanning mechanism configured to scan a local window across sub-regions of the image to obtain respective sub-region pixel sets;
a mechanism configured to input the sub-region pixel sets into a classifier configured to provide output pixel values based on the sub-region pixel sets, each output pixel value representing a likelihood that respective image pixels have a predetermined abnormality, the output pixel values collectively determining a likelihood distribution map; and
a mechanism configured to score the likelihood distribution map to classify the target structure into the predetermined abnormality types.

6. A computer program product storing instructions which when executed by a computer programmed with the stored instructions causes the computer to execute a process for classifying a target structure in an image into predetermined abnormality types by performing the steps comprising:
scanning a local window across sub-regions of the image to obtain respective sub-region pixel sets;
inputting the sub-region pixel sets into a classifier, wherein the classifier provides, corresponding to the sub-regions, respective output pixel values that each represent a likelihood that respective image pixels have a predetermined abnormality, the output pixel values collectively determining a likelihood distribution map; and
scoring the likelihood distribution map to classify the target structure into the predetermined abnormality types.

7. A method for determining a likelihood of a predetermined abnormality for a target structure in an image, comprising:
scanning a local window across sub-regions of the image to obtain respective sub-region pixel sets;
inputting the sub-region pixel sets to N classifiers, N being an integer greater than 1, the N classifiers being configured to output N respective outputs, wherein each of the N classifiers provides, corresponding to the sub-regions, respective output pixel values that each represent a likelihood that respective image pixels have the predetermined abnormality, the output pixel values collectively determining a likelihood distribution map;
scoring the N likelihood distribution maps determined by the N classifiers in the inputting step to generate N respective scores indicating whether the target structure is the predetermined abnormality; and
combining the N scores determined in the scoring step to determine an output value indicating a likelihood that the target structure is the predetermined abnormality.

8. The method of claim 7, wherein the combining step comprises:
combining the N scores to determine the output value, wherein the output value is a continuous, non-binary value indicating a likelihood that a nodule structure in the image is malignant.

9. A system for determining a likelihood of a predetermined abnormality for a target structure in an image, comprising:
a scanning mechanism configured to scan a local window across sub-regions of the image to obtain respective sub-region pixel sets;
N classifiers configured to receive the sub-region pixel sets obtained by the scanning mechanism, N being an integer greater than 1, and to output N respective outputs, wherein each of the N classifiers provides, corresponding to the sub-regions, respective output pixel values that each represent a likelihood that respective image pixels have the predetermined abnormality, the output pixel values collectively determining a likelihood distribution map;
a mechanism configured to score the N likelihood distribution maps determined by the N classifiers to generate N respective scores indicating whether the target structure is the predetermined abnormality; and
a combining classifier configured to combine the N scores determined by the mechanism configured to score to determine an output value indicating a likelihood that the target structure is the predetermined abnormality.

10. The system of claim 9, further comprising:
a mechanism configured to identify structures in the image.

11. The system of claim 9, wherein at least one of the classifiers is a massive training artificial neural network (MTANN).

12. The system of claim 9, further comprising:
a graphical user interface configured to display the output value indicating the likelihood that the target structure is the predetermined abnormality.

13. A computer program product storing instructions which when executed by a computer programmed with the stored instructions causes the computer to execute a process for determining a likelihood of a predetermined abnormality for a target structure in an image by performing steps comprising:
scanning a local window across sub-regions of the image to obtain respective sub-region pixel sets;
inputting the sub-region pixel sets to N classifiers, N being an integer greater than 1, the N classifiers being configured to output N respective outputs, wherein each of the N classifiers provides, corresponding to the sub-regions, respective output pixel values that each represent a likelihood that respective image pixels have the predetermined abnormality, the output pixel values collectively determining a likelihood distribution map;
scoring the N likelihood distribution maps determined by the N classifiers in the inputting step to generate N respective scores indicating whether the target structure is the predetermined abnormality; and
combining the N scores determined in the scoring step to determine an output value indicating a likelihood that the target structure is the predetermined abnormality.

14. A method for determining likelihoods of predetermined abnormality types for a target structure in an image, comprising:
scanning a local window across sub-regions of the image to obtain respective sub-region pixel sets;
inputting the sub-region pixel sets to N classifiers, N being an integer greater than 1, each of the N classifiers being configured to output N outputs, wherein each output of each of the N classifiers provides, corresponding to the sub-regions, respective output pixel values that each represent a likelihood that respective image pixels have one of the predetermined abnormality types, the output pixel values for each output of each of the N classifiers collectively determining a likelihood distribution map, so that N² likelihood distribution maps are determined for the image;
scoring, for each of the N classifiers, the N likelihood distribution maps determined by each classifier in the inputting step to generate N respective scores for each classifier indicating, for each classifier, whether the target structure is one of the predetermined abnormality types, so that N² scores are determined for the image; and
combining, for each abnormality type of the predetermined abnormality types, N scores, one score associated with each of the N classifiers and indicating whether the target structure is of the abnormality type, to obtain an output value indicating a likelihood that the target structure is of the abnormality type, so that N output values are determined, one for each abnormality type of the predetermined abnormality types.

15. A system for determining likelihoods of predetermined abnormality types for a target structure in an image, comprising:
a scanning mechanism configured to scan a local window across sub-regions of the image to obtain respective sub-region pixel sets;
N classifiers, each of the N classifiers configured to receive the sub-region pixel sets, N being an integer greater than 1, and to output N outputs, wherein each output of each of the N classifiers provides, corresponding to the sub-regions, respective output pixel values that each represent a likelihood that respective image pixels have one of the predetermined abnormality types, the output pixel values for each output of each of the N classifiers collectively determining a likelihood distribution map so that N² likelihood distribution maps are determined for the image;
N scoring mechanisms, each scoring mechanism configured to score, for a corresponding classifier, the N likelihood distribution maps determined by each classifier to generate N respective scores for each classifier indicating, for each classifier, whether the target structure is one of the predetermined abnormality types, so that N² scores are determined for the image; and
N combining classifiers, each combining classifier configured to combine, for each abnormality type of the predetermined abnormality types, N scores, one score associated with each of the N classifiers and indicating whether the target structure is of the abnormality type, to obtain an output value indicating a likelihood that the target structure is of the abnormality type, so that N output values are determined, one for each abnormality type of the predetermined abnormality types.

16. The system of claim 15, further comprising:
means for displaying the N output values.

17. The system of claim 15, further comprising:
a graphical user interface configured to display the N output values indicating the likelihood that the target structure is of the predetermined abnormality types.

18. The system of claim 17, further comprising:
means for displaying the N output values in the image adjacent to the target structure.

19. The system of claim 15, wherein N is greater than two.

20. A computer program product storing instructions which when executed by a computer programmed with the stored instructions causes the computer to execute a process for determining likelihoods of predetermined abnormality types for a target structure in an image by performing steps comprising:
scanning a local window across sub-regions of the image to obtain respective sub-region pixel sets;
inputting the sub-region pixel sets to N classifiers, N being an integer greater than 1, each of the N classifiers being configured to output N outputs, wherein each output of each of the N classifiers provides, corresponding to the sub-regions, respective output pixel values that each represent a likelihood that respective image pixels have one of the predetermined abnormality types, the output pixel values for each output of each of the N classifiers collectively determining a likelihood distribution map so that N² likelihood distribution maps are determined for the image;
scoring, for each of the N classifiers, the N likelihood distribution maps determined by each classifier in the inputting step to generate N respective scores for each classifier indicating, for each classifier, whether the target structure is one of the predetermined abnormality types so that N² scores are determined for the image; and
combining, for each abnormality type of the predetermined abnormality types, N scores, one score associated with each of the N classifiers and indicating whether the target structure is of the abnormality type, to obtain an output value indicating a likelihood that the target structure is of the abnormality type, so that N output values are determined, one for each abnormality type of the predetermined abnormality types.

21. A system for indicating the likelihood that a lesion in a medical image is one of a first or second type of abnormality, comprising:
a first classifier, configured to analyze a subset of the image, the first classifier being optimized to recognize the first type of abnormality, and configured to output a first score indicative of the likelihood that the lesion is of the first or second type of abnormality;
a second classifier, configured to analyze a subset of the image, the second classifier being optimized to recognize the second type of abnormality, and configured to output a second score indicative of the likelihood that the lesion is of the first or second type; and
a third classifier, configured to combine the first and second scores and to output a third score indicative of the likelihood that the lesion is of the first or second type.

22. The system of claim 21, wherein the first type of abnormality is a benign lesion, and the second type of abnormality is a malignant lesion.

23. A system for indicating at least one score indicative of the likelihood that a target lesion in a medical image is one of a first, second, or third type of abnormality, comprising:
a first classifier, configured to analyze a subset of the image, the first classifier being optimized to recognize the first type of abnormality, and configured to output a first set of three scores, which indicate, respectively, the likelihood that the target lesion is of the first, second, or third type of abnormality;
a second classifier, configured to analyze a subset of the image, the second classifier being optimized to recognize the second type of abnormality, and configured to output a second set of three scores, which indicate, respectively, the likelihood that the target lesion is of the first, second, or third type of abnormality;
a third classifier, configured to analyze a subset of the image, the third classifier being optimized to recognize the third type of abnormality, and configured to output a third set of three scores, which indicate, respectively, the likelihood that the target lesion is of the first, second, or third type of abnormality;
a fourth classifier, configured to combine the three scores from the first, second, and third classifiers that indicate that the target lesion is of the first type of abnormality, and to output a tenth score indicative of the likelihood that the target lesion is of the first type of abnormality;
a fifth classifier, configured to combine the three scores from the first, second, and third classifiers that indicate that the target lesion is of the second type of abnormality and to output a eleventh score indicative of the likelihood that the target lesion is of the second type of abnormality;
a sixth classifier, configured to combine the three scores from the first, second, and third classifiers that indicate that the target lesion is of the third type of abnormality and to output a twelfth score indicative of the likelihood that the target lesion is of the third type of abnormality; and
a graphical user interface configured to display a representation of at least one of the tenth, eleventh, and twelfth scores.

24. The system of claim 23, wherein the displayed representation is at least one numerical value.

25. The system of claim 23, wherein the displayed representation is a graphical representation indicating which of the first, second, and third types of abnormality have the highest likelihood.

26. The system of claim 25, wherein the displayed representation is a color; and
the system further comprises a means to indicate to a user the correspondence between the color and the type of abnormality having the highest likelihood.

27. The system of claim 23, wherein the displayed representation is displayed adjacent to the image of the target lesion.

28. The system of claim 23, wherein the displayed representation is superimposed on the image of the target lesion.

29. The system of claim 23, wherein the displayed representation is at least two numerical values.

30. A system for indicating at least one score indicative of the likelihood that a target lesion in a medical image is one of N types of abnormality, comprising:
a first set of N classifiers, wherein each classifier in the first set is configured to analyze a subset of the image, and each classifier is optimized to recognize a different one of the N types of abnormalities, and each classifier in the first set is configured to output a first set of N scores, wherein each of the N scores outputted by each classifier indicates the likelihood that the target lesion is one of a different one of the N types of abnormalities;
a second set of N classifiers, wherein each classifier in the second set is configured to combine the one score outputted by each of the first set of N classifiers that indicates that the target lesion is of a single type of abnormality, and wherein each classifier in the second set is configured to combine a different set of N scores; and wherein each of the second set of N classifiers is configured to output one element of a set of N combined scores each indicating the likelihood that the target lesion is of the said single type of abnormality; and
a graphical user interface configured to display a representation of at least one of the set of N combined scores.

31. A system for indicating the likelihood that an identified region in a medical image is a malignant lesion, or one of a plurality of benign types of abnormalities, comprising:
a first classifier configured to analyze a subset of the image, the first classifier optimized to output a first score indicating whether the identified region is a malignant lesion;
a plurality of additional classifiers each configured to analyze a subset of the image and each optimized to output additional scores indicating whether the suspicious region is one of the different benign types of abnormalities;
a combining classifier configured to combine the first score and the additional scores and to output a set of final scores indicating the likelihoods that the identified region contains a malignant lesion, or one of the plurality of benign types of abnormalities.

32. A system for indicating the likelihood that an identified region in a medical image is one of a plurality of types of abnormalities, comprising:
a plurality of classifiers each configured to analyze a subset of the image and each optimized to output a first score indicating whether the identified region is one of the different types of abnormalities;
a combining classifier configured to combine the set of first scores and to output a set of final scores indicating the likelihoods that the identified region contains one of the plurality of types of abnormalities; and
a graphical user interface configured to display at least one indicator representative of at least one final score of the set of final scores.

33. The system of claim 32, wherein the plurality of abnormalities are indicative of diseases selected from a group comprising fibrosis, scleroderma, polymyositis, rheumatoid arthritis, dermatopolymyositis, aspiration pneumonia, pleural effusion, pulmonary fibrosis, pulmonary hypertension, scleroderma pulmonary, autoimmune interstitial pneumonia, pulmonary veno-occlusive disease, shrinking lung syndrome, lung cancer, and pulmonary embolism.

34. A system for indicating the likelihood that an identified region in an image of a lung is one of N types of abnormalities, comprising:
N classifiers each configured to analyze a subset of the image and each optimized to output one of a first set of N scores indicating whether the identified region is one of the different types of abnormalities;
an additional combining classifier, configured to combine the first set of scores and to output at least one final score indicating at least one likelihood that the identified region is one of the plurality of types of abnormalities; and
a graphical user interface configured to display at least one indicator representative of the at least one final score.
